(19) United States
(12) Patent Application Publication
(10) Pub. No.: US 2015/0177866 A1
(43) Pub. Date: Jun. 25, 2015

(54) Multiple Hover Point Gestures

(71) Applicant: Microsoft Corporation, Redmond, WA (US)

(72) Inventors: Dan Hwang, New Castle, WA (US); Scott Greenlay, Redmond, WA (US); Christopher Fellowes, Redmond, WA (US); Bob Schriver, Seattle, WA (US)

(21) Appl. No.: 14/138,238

(22) Filed: Dec. 23, 2013

(51) Int. Cl. G06F 3/042; G06F 3/01

(52) U.S. Cl. CPC G06F 3/042; G06F 3/017

(57) ABSTRACT

Example apparatus and methods concern detecting and responding to a multiple hover point gesture performed for a hover-sensitive device. An example apparatus may include a hover-sensitive input/output interface configured to detect multiple objects in a hover-space associated with the hover-sensitive input/output interface. The apparatus may include logics configured to identify an object in the hover-space, to characterize an object in the hover-space, to track an object in the hover-space, to identify a multiple hover point gesture based on the identification, characterization, and tracking, and to control a device, application, interface, or object based on the multiple hover point gesture. In different embodiments, multiple hover point gestures may be performed in one, two, three, or four dimensions. In one embodiment, the apparatus may be event driven with respect to handling gestures.

### BACKGROUND

Users of smart phones, tablets, and other touch devices are familiar with touching the screen of the device to cause the device to perform an action. The touch action generally simulates a mouse click or button press. Conventionally, touch-sensitive screens have also supported gestures where one or two fingers were placed on the touch-sensitive screen then moved in an identifiable pattern. For example, users may interact with an input/output interface on the touch-sensitive screen using gestures like a swipe, a pinch, a spread, a tap or double tap, or other gestures. Conventionally, the touch-sensitive screen had a single touch point, or a pair of touch points for gestures like a pinch.

Devices like smart phones and tablets may also be configured with screens that are hover-sensitive. Hover-sensitive screens may rely on proximity detectors to detect objects that are within a certain distance of the screen. Conventional hover-sensitive screens detected single objects in a hover-space associated with the hover-sensitive device and responded to events like a hover-space entry event or a hover-space exit event. Conventional hover-sensitive devices typically attempted to implement actions that were familiar to users of touch-sensitive devices. When presented with two or more objects in a hover-space, a hover-sensitive device may have identified the first entry as being the hover point and may have ignored other items in the hover-space.

Some devices may have screens that are both touch-sensitive and hover-sensitive. Conventionally, devices with screens that are both touch-sensitive and hover-sensitive may have responded to touch events or to hover events. While a rich set of interactions may be possible using a screen in a touch mode or a hover mode, this binary approach may have limited the richness of the experience possible for an interface that is both touch-sensitive and hover-sensitive. Some conventional devices may have responded to gestures that started with a touch event and then proceeded to a hover event. Limiting interactions to require an initiating touch may have needlessly limited the user experience. Some devices with screens that are both touch-sensitive and hover-sensitive may have interacted with a single touch point or a single hover point. Limiting interactions to a single touch or hover point may have limited the richness of the experience possible to users of devices. Some conventional devices may have responded to hover gestures that were tied to an object displayed on the screen. For example, hovering over a displayed control may have accessed the control. The control may then have been manipulated using a gesture (e.g., swipe up, swipe down). Limiting hover interactions to only operate on objects or controls that are displayed on a screen may needlessly limit the user experience.

### SUMMARY

This Summary is provided to introduce, in a simplified form, a selection of concepts that are further described below in the Detailed Description. This Summary is not intended to identify key features or essential features of the claimed subject matter, nor is it intended to be used to limit the scope of the claimed subject matter.

Example methods and apparatus are directed towards interacting with a hover-sensitive device using gestures that include multiple hover points. A multiple hover point gesture may rely on a sequence or combination of gestures to produce a different user interaction with a screen that has hover-sensitivity. The multiple hover point gestures may include a hover gather, a hover spread, a crank or knob gesture, a poof or explode gesture, a slingshot gesture, or other gesture. By identifying, characterizing, and tracking multiple hover points using the hover capability provided by an interface that is hover-sensitive, example methods and apparatus provide new gestures that may be intuitive for users and that may increase productivity or facilitate new interactions with applications (e.g., games, email, video editing) running on a device with the interface.

Some embodiments may include logics that detect, characterize, and track multiple hover points. Some embodiments may include logics that identify elements of the multiple hover point gestures from the detection, characterization, and tracking data. Some embodiments may maintain a state machine and user interface in response to detecting the elements of the multiple hover point gestures. Detecting elements of the multiple hover point gestures may involve receiving events from the user interface. For example, events like a hover enter event, a hover exit event, a hover approach event, a hover retreat event, a hover point move event, or other events may be detected as a user positions and moves their fingers or other objects in a hover-space associated with a device. Some embodiments may also produce gesture events that can be handled or otherwise processed by other devices or processes.

### BRIEF DESCRIPTION OF THE DRAWINGS

The accompanying drawings illustrate various example apparatus, methods, and other embodiments described herein. It will be appreciated that the illustrated element boundaries (e.g., boxes, groups of boxes, or other shapes) in the figures represent one example of the boundaries. In some examples, one element may be designed as multiple elements or multiple elements may be designed as one element. In some examples, an element shown as an internal component of another element may be implemented as an external component and vice versa. Furthermore, elements may not be drawn to scale.

FIG. 1 illustrates an example hover-sensitive device.

FIG. 2 illustrates an example state diagram associated with an example multiple hover point gesture.

FIG. 3 illustrates an example multiple hover point gather gesture.

FIG. 4 illustrates an example multiple hover point spread gesture.

FIG. 5 illustrates an example interaction with an example hover-sensitive device.

FIG. 6 illustrates actions, objects, and data associated with a multiple hover point gesture.

FIG. 7 illustrates actions, objects, and data associated with a multiple hover point gesture.

FIG. 8 illustrates actions, objects, and data associated with a multiple hover point gesture.

FIG. 9 illustrates actions, objects, and data associated with a multiple hover point gesture.

FIG. 10 illustrates actions, objects, and data associated with a multiple hover point gesture.

FIG. 11 illustrates actions, objects, and data associated with a multiple hover point gesture.

FIG. 12 illustrates actions, objects, and data associated with a multiple hover point gesture.

FIG. 13 illustrates actions, objects, and data associated with a multiple hover point gesture.

FIG. 14 illustrates actions, objects, and data associated with a multiple hover point gesture.

FIG. 15 illustrates an example method associated with a multiple hover point gesture.

FIG. 16 illustrates an example method associated with a multiple hover point gesture.

FIG. 17 illustrates an example apparatus configured to support a multiple hover point gesture.

FIG. 18 illustrates an example apparatus configured to support a multiple hover point gesture.

FIG. 19 illustrates an example cloud operating environment in which an apparatus configured to interact with a multiple hover point gesture may operate.

FIG. 20 is a system diagram depicting an exemplary mobile communication device configured to interact with a user through a multiple hover point gesture.

FIG. 21 illustrates an example z distance and z direction in an example apparatus configured to process a multiple hover point gesture.

FIG. 22 illustrates an example displacement in an x-y plane and in a z direction from an initial point.

### DETAILED DESCRIPTION

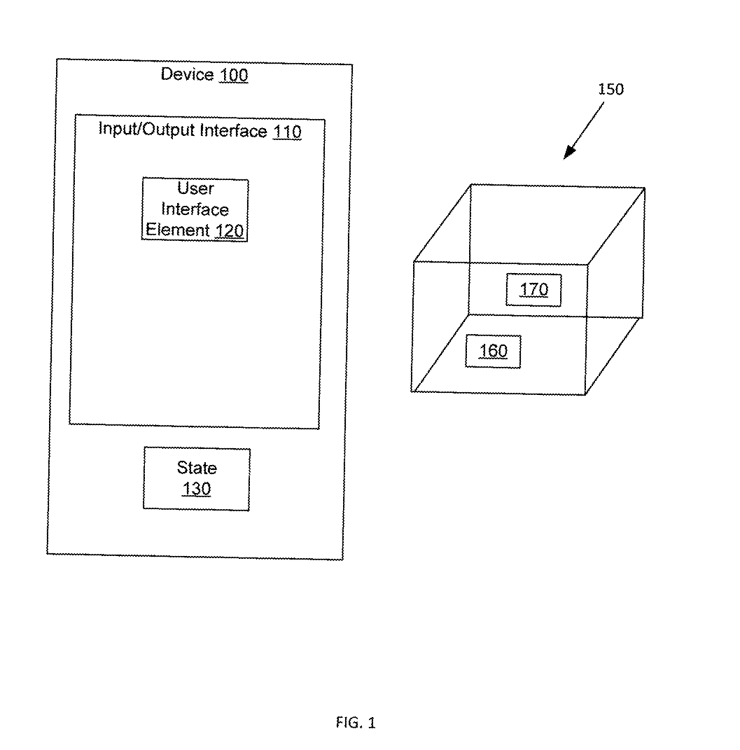

Example apparatus and methods concern multiple hover point gesture interactions with a device. The device may have an interface that is hover-sensitive. FIG. 1 illustrates an example hover-sensitive device 100. Device 100 includes an input/output (i/o) interface 110. I/O interface 110 is hover-sensitive. I/O interface 110 may display a set of items including, for example, a user interface element 120. User interface elements may be used to display information and to receive user interactions. Device 100 or i/o interface 110 may store state 130 about the user interface element 120 or other items that are displayed. The state 130 of the user interface element 120 may depend on hover gestures. The state 130 may include, for example, the location of an object displayed on the i/o interface 110, whether the object has been bracketed, or other information. The state information may be saved in a computer memory.

The device 100 may include a proximity detector that detects when an object (e.g., digit, pencil, stylus with capacitive tip) is close to but not touching the i/o interface 110. Hover user interactions may be performed in the hover-space 150 without touching the device 100. The proximity detector may identify the location (x, y, z) of an object (e.g., finger) 160 in the three-dimensional hover-space 150, where x and y are parallel to the proximity detector and z is perpendicular to the proximity detector. The proximity detector may also identify other attributes of the object 160 including, for example, how close the object 160 is to the i/o interface (e.g., z distance), the speed with which the object 160 is moving in the hover-space 150, the orientation (e.g., pitch, roll, yaw) of the object 160 with respect to the device 100 or hover-space 150, the direction in which the object 160 is moving with respect to the hover-space 150 or device 100 (e.g., approaching, retreating), a gesture (e.g., gather, spread) made by the object 160, or other attributes of the object 160. While conventional interfaces may have handled a single object, the proximity detector may detect more than one object in the hover-space 150. For example, object 160 and object 170 may be simultaneously detected, characterized, tracked, and considered together as performing a multiple hover point gesture.

In different examples, the proximity detector may use active or passive systems. For example, the proximity detector may use sensing technologies including, but not limited to, capacitive, electric field, inductive, Hall effect, Reed effect, Eddy current, magneto resistive, optical shadow, optical visual light, optical infrared (IR), optical color recognition, ultrasonic, acoustic emission, radar, heat, sonar, conductive, and resistive technologies. Active systems may include, among other systems, infrared or ultrasonic systems. Passive systems may include, among other systems, capacitive or optical shadow systems. In one embodiment, when the proximity detector uses capacitive technology, the detector may include a set of capacitive sensing nodes to detect a capacitance change in the hover-space 150. The capacitance change may be caused, for example, by a digit(s) (e.g., finger, thumb) or other object(s) (e.g., pen, capacitive stylus) that comes within the detection range of the capacitive sensing nodes. In another embodiment, when the proximity detector uses infrared light, the proximity detector may transmit infrared light and detect reflections of that light from an object within the detection range (e.g., in the hover-space 150) of the infrared sensors. Similarly, when the proximity detector uses ultrasonic sound, the proximity detector may transmit a sound into the hover-space 150 and then measure the echoes of the sounds. In another embodiment, when the proximity detector uses a photo-detector, the proximity detector may track changes in light intensity. Increases in intensity may reveal the removal of an object from the hover-space 150 while decreases in intensity may reveal the entry of an object into the hover-space 150.

In general, a proximity detector includes a set of proximity sensors that generate a set of sensing fields in the hover-space 150 associated with the i/o interface 110. The proximity detector generates a signal when an object is detected in the hover-space 150. In one embodiment, a single sensing field may be employed. In other embodiments, two or more sensing fields may be employed. In one embodiment, a single technology may be used to detect or characterize the object 160 in the hover-space 150. In another embodiment, a combination of two or more technologies may be used to detect or characterize the object 160 in the hover-space 150.

In one embodiment, characterizing the object includes receiving a signal from a detection system (e.g., proximity detector) provided by the device. The detection system may be an active detection system (e.g., infrared, ultrasonic), a passive detection system (e.g., capacitive), or a combination of systems. The detection system may be incorporated into the device or provided by the device.

Characterizing the object may also include other actions. For example, characterizing the object may include determining that an object (e.g., digit, stylus) has entered the hover-space or has left the hover-space. Characterizing the object may also include identifying the presence of an object at a pre-determined location in the hover-space. The pre-determined location may be relative to the i/o interface.

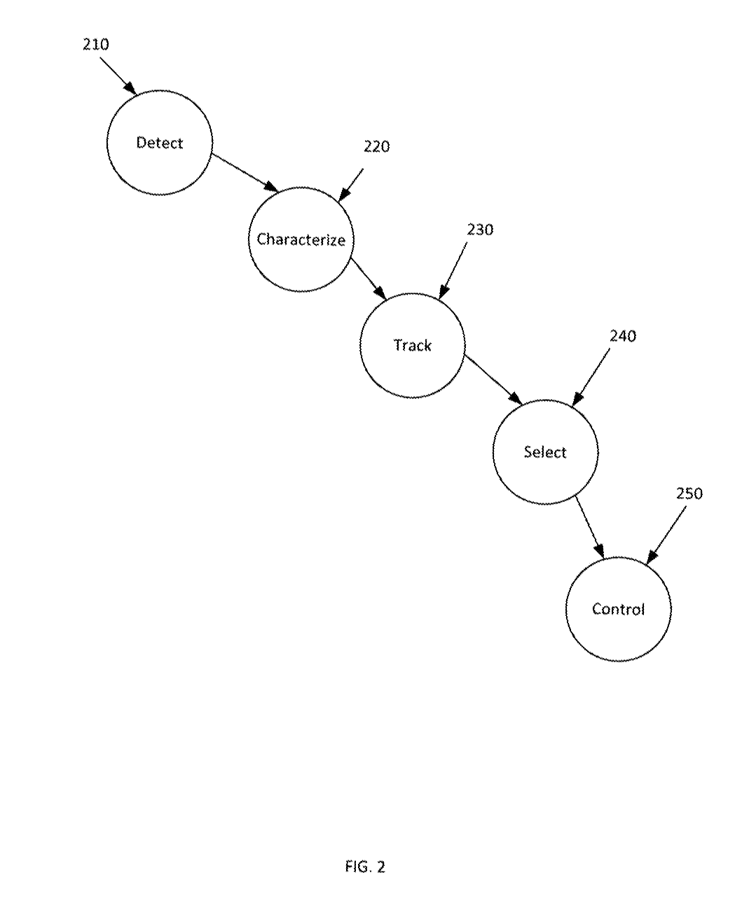

FIG. 2 illustrates a state diagram associated with supporting multiple hover point gestures. When a hover-sensitive apparatus detects multiple objects (e.g., fingers, thumbs, stylus) in the hover-space associated with the apparatus, the detect state 210 associated with a multiple hover point gesture may be entered. Once multiple objects have been identified, the individual objects may be characterized on attributes including, but not limited to, position (e.g., x,y,z co-ordinates), size (e.g., width, length), shape (e.g., round, elliptical, square, rectangular), and motion (e.g., approaching, retreating, moving in x-y plane). The characterization may be performed when a hover point enter event occurs and may be repeated when a hover point move event occurs. When two or more objects in the hover-space have been characterized, then the characterize state 220 may be achieved.

When at least one of the multiple hover points that were characterized moves, example apparatus and methods may track the movement of the hover point. The tracking may involve relating characterizations that are performed at different times. When at least one of the multiple hover points that were characterized has been tracked, then the track state 230 may be achieved. Once multiple hover points have been detected, characterized, and tracked, it may be possible to select a multiple hover point gesture based, at least in part, on the size, shape, movement, and relative movement of the hover points. For example, multiple hover points that move inwards towards each other may describe a gather gesture while multiple hover points that move outwards from each other may describe a spread gesture. Multiple hover points that rotate about a central point may describe a crank or knob gesture. When the identification, characterization, and tracking data match a gesture pattern, then the select state 240 may be achieved.

Once the select state 240 has been achieved, actions that preceded the selection or actions that follow the selection may be evaluated to determine what control to exercise during the control state 250. During the control state 250, the multiple hover point gesture may cause the apparatus to be controlled (e.g., turn on, turn off, increase volume, decrease volume, increase intensity, decrease intensity), may cause an application being run on the device to be controlled (e.g., start application, stop application, pause application), may cause an object displayed on the device to be controlled (e.g., moved, rotated, size increased, size decreased), or may cause other actions.

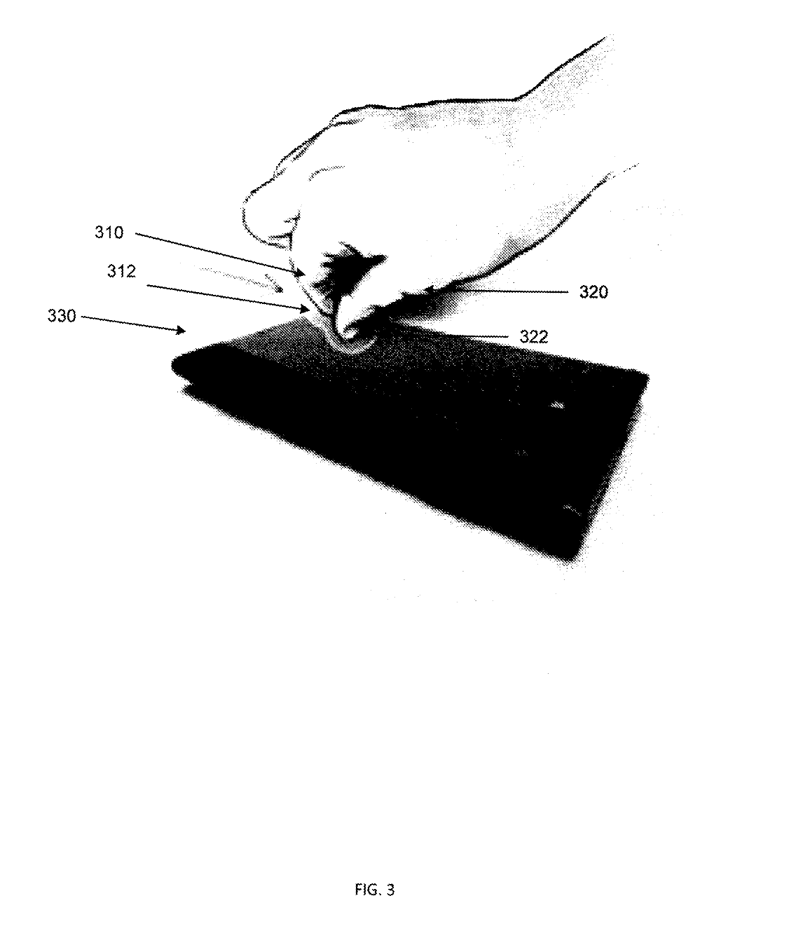

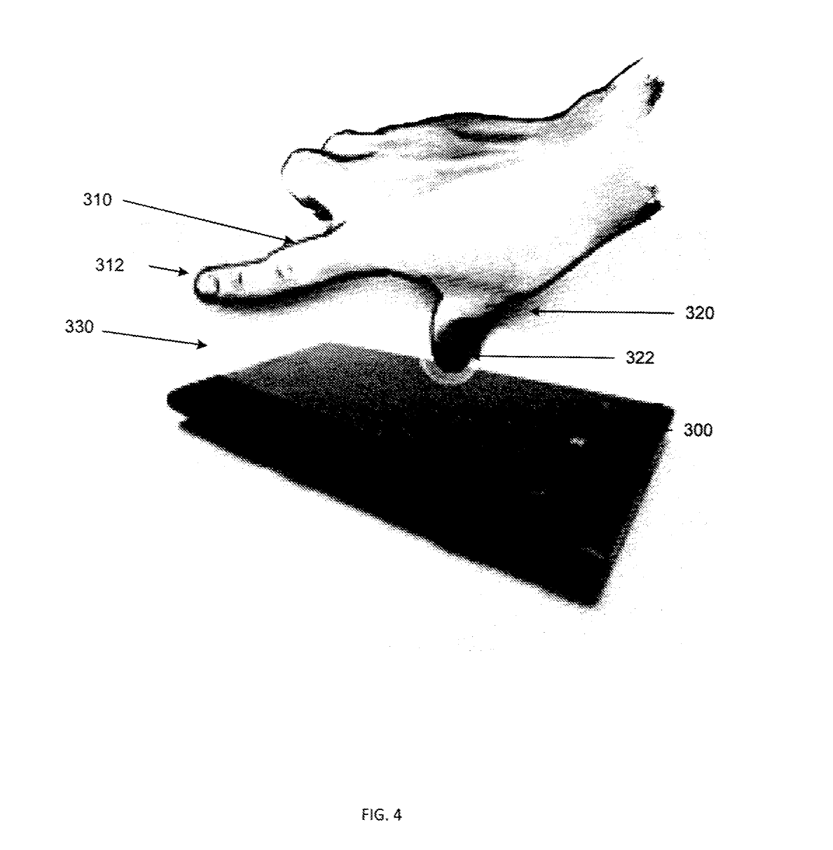

FIGS. 3 and 4 illustrate multiple hover point gather and spread gestures that may be recognized by users of touch sensitive devices. Unlike their touch sensitive cousins, the gather and spread gestures may operate in one, two, three, or even four dimensions. A conventional pinch gesture brings two points together along a single line. A multiple hover point gather gesture may bring points together in an x/y plane, but may also reposition the points in the z direction at the same time. A conventional pinch gesture requires a user to put two fingers onto a flat touch screen. This may be difficult if even possible to achieve when the device is being held in one hand, when the device is just out of reach, when the device is oriented at an awkward angle, or for other reasons. For example, a user's fingers and thumbs may be different lengths. To perform a conventional touch screen pinch gesture, a user may need to re-orient the device to accommodate the different lengths of their digits, or may need to tilt, rotate, lift, or otherwise manipulate their digits to match the flat touch screen. This may be extremely difficult for a person with arthritis in their hands or fingers. A multiple hover point gather gesture is not limited like the conventional pinch gesture. A multiple hover point gather gesture is performed without touching the screen. The digits do not need to be exactly the same distance from the screen. The gather may be performed without first referencing a particular object on a display by touching or otherwise identifying the object. Conventional pinch gestures typically require first selecting an item or control and then pinching the object. Example apparatus and methods are not so limited, and may generate a gather control event regardless of what, if anything, is displayed on a screen.

FIG. 3 illustrates an example multiple hover point gather gesture. Fingers 310 and 320 are positioned in an x-y plane 330 in the hover-space above device 300. While an x-y plane is described, more generally, fingers may be placed in a volume above device 300 and moved in x and y directions. Fingers 310 and 320 have moved together in the x-y plane or volume over apparatus 300. Finger 310 is closer to the hover-sensitive screen than finger 320. In one embodiment, example apparatus and methods may measure the distance from the screen to the fingers in the z direction. Apparatus 300 has identified hover points 312 and 322 associated with fingers 310 and 320 respectively. As the fingers 310 and 320 move together, the hover points 312 and 322 also move together. When the hover points 312 and 322 have moved close enough together, then a multiple hover point gather may be performed. The gather gesture may be used to reduce screen brightness, to limit a social circle with which a user interacts, to make an object smaller, to zoom in on a picture, to gather an object to be lifted, to crush a virtual grape, to control device volume, or for other reasons.

Unlike a conventional touch screen pinch gesture where only two points are brought together, example gather gestures may be extended to include a three, four, five, or more point gather gesture. Thus, rather than simply bringing two points together along a single connecting line, example multiple hover point gather gestures may gather together items in a virtual area or volume, rather than collapsing points along a line. Thus, rather than simply pinching a single item represented in a flat space on a display, a multiple hover point gather may grab multiple objects represented in a three dimensional display. Additionally, rather than manipulating an object in just one dimension (e.g., linearly decrease size of object pinched), example apparatus and methods may manipulate an object in three dimensions. For example, a sphere or other three dimensional volume (e.g., apple) that is manipulated by a multiple hover point gather gesture may shrink spherically, rather than just linearly. In one embodiment, the multiple hover point gather gesture may simply bring two points together in an x/y plane along a single connecting line. Example apparatus and methods may perform the gather gesture without requiring interaction with a touch screen, without requiring interaction with a camera-based system, and without reference to any particular object displayed on device 300. Note that device 300 is not displaying any objects. The gather gesture may be used with respect to objects, but may also be used to control things other than individual objects displayed on device 300. Thus, example apparatus and methods may operate more independently than conventional systems that require touches, cameras, or interactions with specific objects.

FIG. 4 illustrates an example multiple hover point spread gesture. Fingers 310 and 320 have moved apart from each other. Thus, corresponding hover points 312 and 322 have also moved apart. This spread may be used to virtually release an object(s) that was pinched, lifted, and carried to a new virtual location. The location at which the object will be placed on the display on apparatus 300 may depend, at least in part, on the location of hover points 312 and 322. Unlike a conventional one dimensional spread gesture performed on a touch screen, the multiple hover point spread gesture may operate in three dimensions. Returning to the spherical object or apple example, multiple hover points may be located inside the virtual sphere and then spread apart. The sphere may then expand in three dimensions instead of just linearly in one direction. In one embodiment, since the apparatus may track the z distance for the multiple hover points, and since the apparatus may track the rate at which the multiple hover points are moving apart, the spread gesture may be used, for example, to throw virtual dust in the air or fling virtual water off the end of fingertips. The volume covered by the virtual dust throw may depend, for example, on the distance from the screen at which the spread was performed and the rate at which the spread was performed. For example, a spread performed slowly may distribute the dust to a smaller volume than a spread performed more rapidly. Additionally, a spread performed farther from the screen may spread the dust more widely than a spread performed close to the screen.

A conventional one dimensional spread may only enlarge a selected object in a single dimension, while an example multiple hover point spread operating in three dimensions may enlarge objects in multiple dimensions. The spread gesture may also be used in other applications like gaming control (e.g., spreading magic dust), arts and crafts (e.g., throwing paint in modem art), industrial control (e.g., spraying a virtual mist onto a control surface), engineering (e.g., computer aided drafting), and other applications. Unlike conventional touch spread gestures that operate to change a single dimension of a single selected item, example apparatus and methods may operate on a set of objects in an area or volume without first identifying or referencing those objects. Instead, a multiple hover point spread gesture may be used to generate a spread control event for which an object, user interface, application, portion of a device, or device may subsequently be selected for control. While users may be familiar with the touch spread gesture to enlarge objects, a hover spread may be performed to control other actions. Note that device 300 is not displaying any objects. This illustrates that the spread may be used to exercise other, non-object centric control. For example, the multiple hover point spread gesture may be used to control broadcast power, social circle size for a notification or post, volume, intensity, or other non-object.

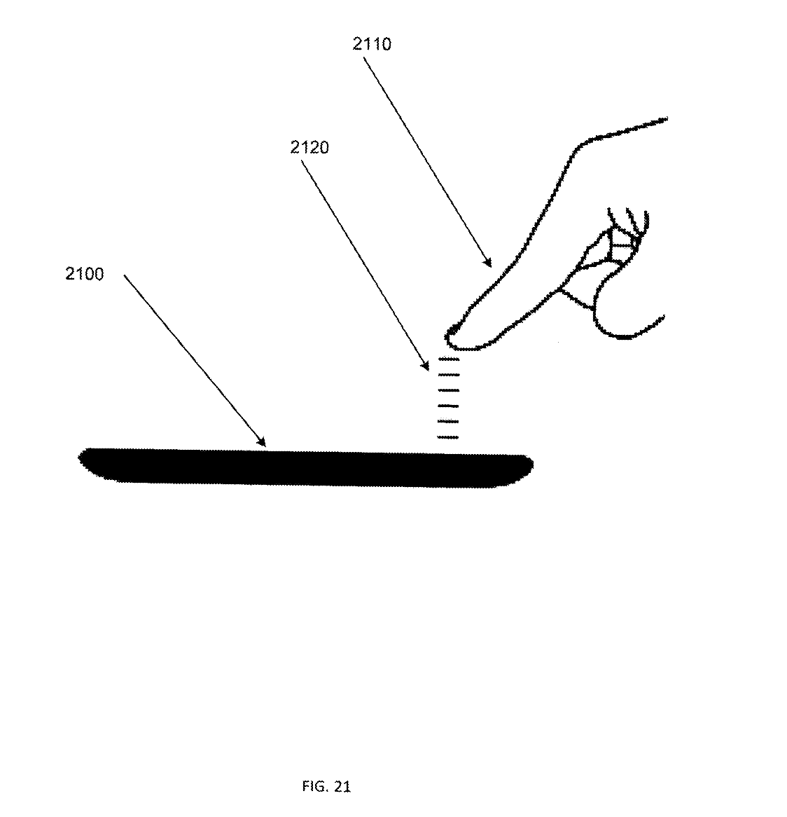

FIG. 21 illustrates an example z distance 2120 and z direction associated with an example apparatus 2100 configured to perform multiple hover point gestures. The z distance may be perpendicular to apparatus 2100 and may be determined by how far the tip of finger 2110 is located from apparatus 2100. While a single finger 2110 is illustrated, a z distance may be computed for multiple hover points in a hover zone. Additionally, whether the z distance is increasing (e.g., finger moving away from apparatus 2100) or decreasing (e.g., finger moving toward apparatus 2100) may be computed. Additionally, the rate at which the z distance is changing may be computed. Thus, unlike conventional two finger touch gestures that may change a parameter in a single dimension, multiple hover point gestures may operate in one, two, three, or even four dimensions. Consider a multiple hover point crank gesture performed using two fingers and a thumb above a virtual screwdriver displayed on a device. The crank gesture may not only cause the virtual screwdriver to rotate in the x and y plane, but the rate at which the fingers are rotating may control how quickly the screwdriver is turned and the rate at which the fingers are approaching the screen may control the virtual pressure to be applied to the virtual screwdriver. Being able to control direction, rate, and pressure may provide a richer user interface experience than a simple one dimensional adjustment.

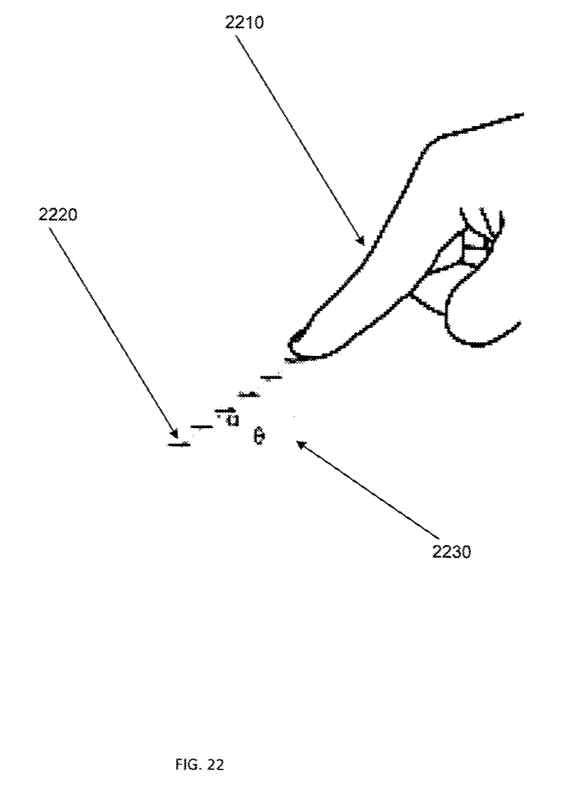

FIG. 22 illustrates an example displacement in an x-y direction from an initial point 2220. Finger 2210 may initially have been located above initial point 2220. Finger 2210 may then have moved to be above subsequent point 2230. In one embodiment, the locations of points 2220 and 2230 may be described by (x,y,z) co-ordinates. In another embodiment, the subsequent point 2230 may be described in relation to initial point 2220. For example, a distance, an angle in the x-y direction, and an angle in the z direction may be employed. While a single finger 2210 is illustrated, example apparatus and methods may track the displacement of multiple hover points. The tracks of the multiple hover points may facilitate identifying a gesture.

Hover technology is used to detect an object in a hover-space. “Hover technology” and “hover-sensitive” refer to sensing an object spaced away from (e.g., not touching) yet in close proximity to a display in an electronic device. “Close proximity” may mean, for example, beyond 1 mm but within 1 cm, beyond 0.1 mm but within 10 cm, or other combinations of ranges. Being in close proximity includes being within a range where a proximity detector can detect and characterize an object in the hover-space. The device may be, for example, a phone, a tablet computer, a computer, or other device. Hover technology may depend on a proximity detector(s) associated with the device that is hover-sensitive. Example apparatus may include the proximity detector(s).

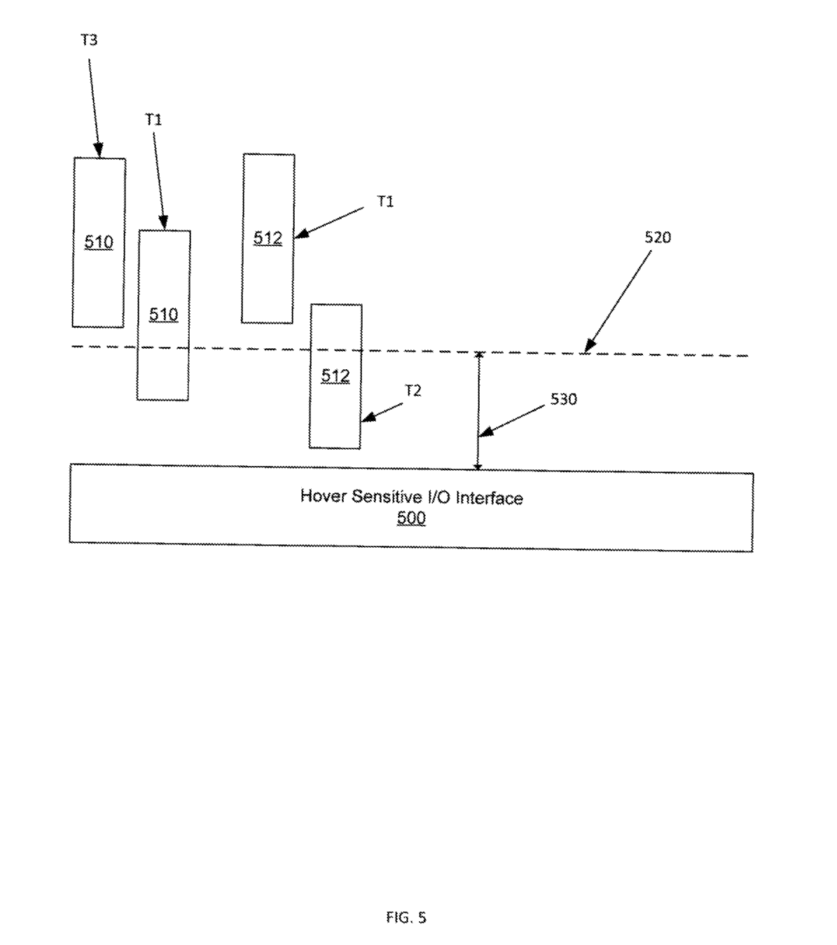

FIG. 5 illustrates a hover-sensitive i/o interface 500. Line 520 represents the outer limit of the hover-space associated with hover-sensitive i/o interface 500. Line 520 is positioned at a distance 530 from i/o interface 500. Distance 530 and thus line 520 may have different dimensions and positions for different apparatus depending, for example, on the proximity detection technology used by a device that supports i/o interface 500.

Example apparatus and methods may identify objects located in the hover-space bounded by i/o interface 500 and line 520. Example apparatus and methods may also identify gestures performed in the hover-space. For example, at a first time T1, an object 510 may be detectable in the hover-space and an object 512 may not be detectable in the hover-space. At a second time T2, object 512 may have entered the hover-space and may actually come closer to the i/o interface 500 than object 510. At a third time T3, object 510 may retreat from i/o interface 500. When an object enters or exits the hover-space an event may be generated. Example apparatus and methods may interact with events at this granular level (e.g., hover enter, hover exit, hover move) or may interact with events at a higher granularity (e.g., hover gather, hover spread). Generating an event may include, for example, making a function call, producing an interrupt, updating a value in a computer memory, updating a value in a register, sending a message to a service, sending a signal, or other action that identifies that an action has occurred. Generating an event may also include providing descriptive data about the event. For example, a location where the event occurred, a title of the event, and an object involved in the object may be identified.

In computing, an event is an action or occurrence detected by a program that may be handled by the program. Typically, events are handled synchronously with the program flow. When handled synchronously, the program may have a dedicated place where events are handled. Events may be handled in, for example, an event loop. Typical sources of events include users pressing keys, touching an interface, performing a gesture, or taking another user interface action. Another source of events is a hardware device such as a timer. A program may trigger its own custom set of events. A computer program that changes its behavior in response to events is said to be event-driven.

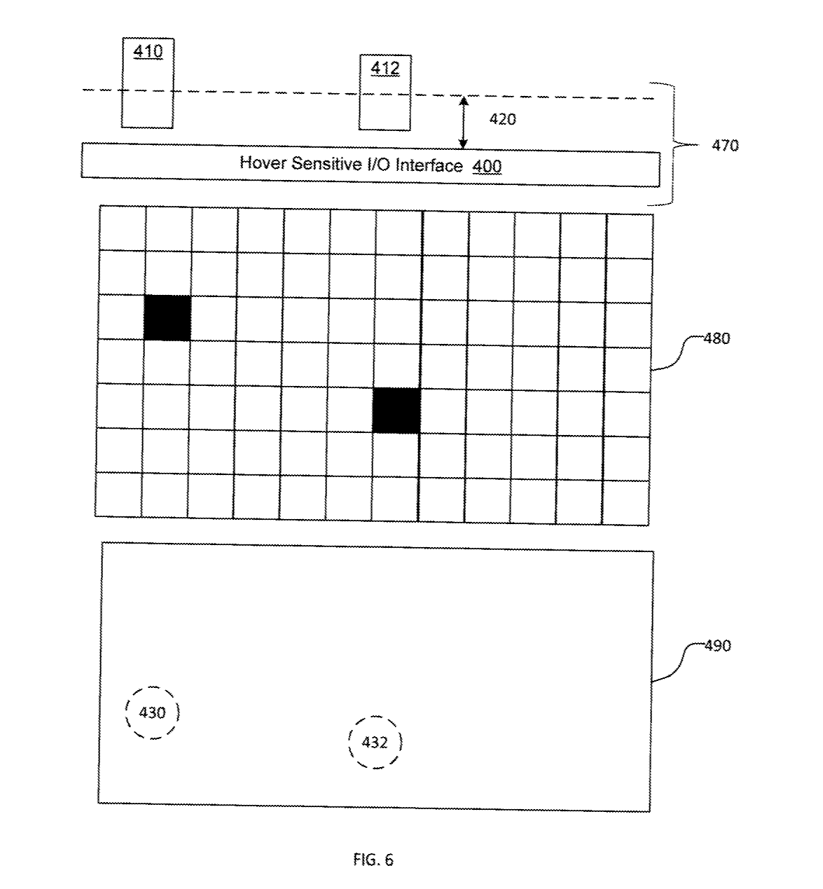

FIG. 6 illustrates actions, objects, and data associated with a multiple hover point gesture. Region 470 provides a side view of an object 410 and an object 412 that are within the boundaries of a hover-space defined by a distance 420 above a hover-sensitive i/o interface 400. Region 480 illustrates a top view of representations of regions of the i/o sensitive interface 400 that are affected by object 410 and object 412. The solid shading of certain portions of region 480 indicates that a hover point is associated with the solid area. Region 490 illustrates a top view representation of a display that may appear on a graphical user interface associated with hover-sensitive i/o interface 400. Dashed circle 430 represents a hover point graphic that may be displayed in response to the presence of object 410 in the hover-space and dashed circle 432 represents a hover point graphic that may be displayed in response to the presence of object 412 in the hover-space. While two hover points have been detected, a user interface state or gesture state may not transition to a multiple hover point gesture start state until some identifiable motion is performed by one or more of the identified hover points. In one embodiment, the dashed circles may be displayed on interface 400 while in another embodiment the dashed circles may not be displayed. Unlike conventional systems, the hover gesture may be a pure hover detect gesture that begins without touching the interface 400, without using a camera, and without reference to any particular item displayed on interface 400.

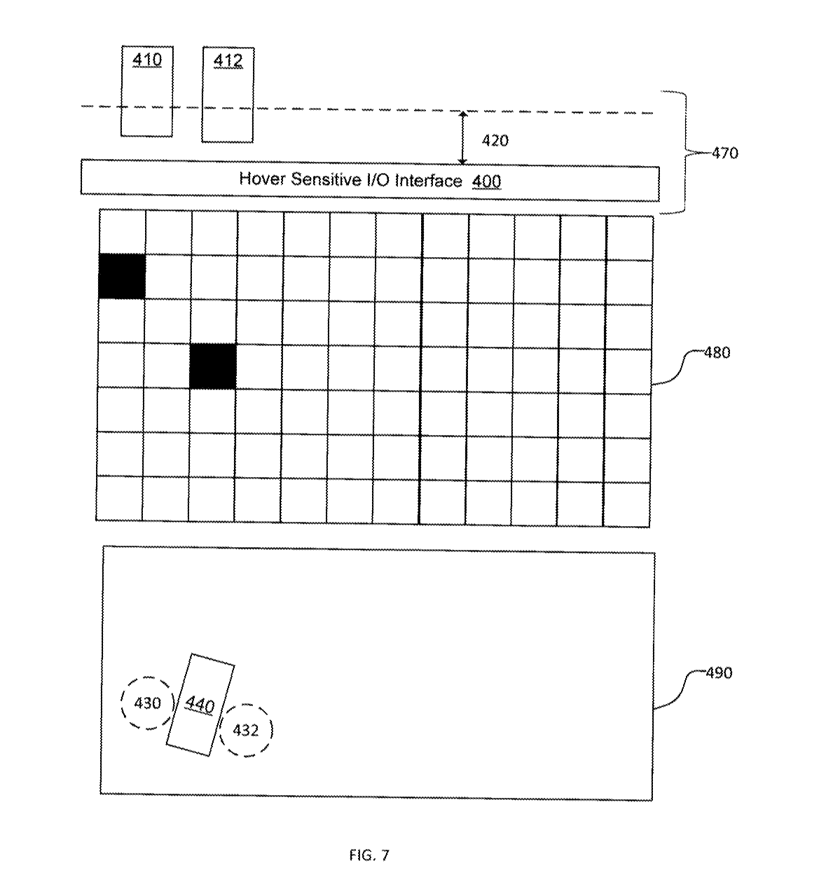

FIG. 7 illustrates actions, objects, and data associated with a multiple hover point gesture. Object 410 and object 412 have moved closer together. Region 480 now illustrates the two solid regions that correspond to the two hover points associated with object 410 and 412 as being closer together. Region 490 now illustrates circle 430 and circle 432 as being closer together. In one embodiment, circle 430 and circle 432 may be displayed while in another embodiment circle 430 and circle 432 may not be displayed. Example apparatus and methods may have identified that multiple hover points were produced in FIG. 6. The hover points may have been characterized when identified. Over time, example apparatus and methods may have tracked the hover points and repeated the characterizations. The tracking and characterization may have been event driven. Based on the relative motion of the hover points, a multi-point gather gesture may be identified.

Region 490 also illustrates an object 440. Object 440 may be a graphic, icon, or other representation of an item displayed by i/o interface 400. Since object 440 has been bracketed by the hover points produced by object 410 and object 412, object 440 may be a target for a multi hover point gesture. The appearance of object 440 may be manipulated to indicate that object 440 is the target of a gesture. If the distance between the hover point associated with circle 430 and the object 440 and the distance between the hover point associated with circle 432 and the object 440 are within gesture thresholds, then the user interface or gesture state may be changed to indicate that a certain gesture (e.g., hover gather) is in progress. While a conventional pinch may operate only on a single object 440 and may require an object to be disposed between touch points, example apparatus and methods are not so limited and may produce a control gather event regardless of whether an object is disposed between the hover points 430 and 432. This type of non-object gather may be used to control an attribute of an apparatus (e.g., reduce transmit power, enter airplane mode) rather than shrinking an object displayed on interface 400.

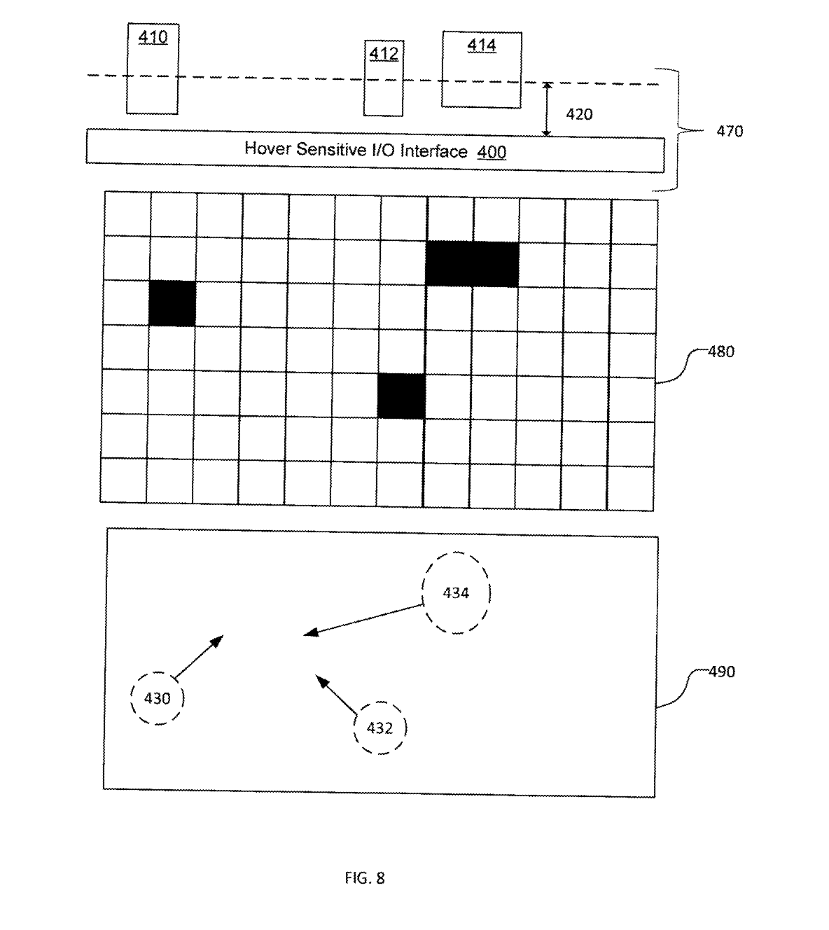

FIG. 8 illustrates actions, objects, and data associated with a multiple hover point gesture. While FIGS. 6 and 7 illustrated two objects, FIG. 8 illustrates three objects. Region 470 provides a side view of an object 410 (e.g., finger) an object 412 (e.g., finger) and an object 414 (e.g., thumb) that are within the boundaries of the hover-space. Region 480 illustrates a top view of representations of regions of the i/o sensitive interface 400 that are affected by objects 410, 412, and 414. Since thumb 414 is larger than fingers 410 and 412, the representation of thumb 414 is larger. Region 490 illustrates a top view representation of a display that may appear on a graphical user interface associated with hover-sensitive i/o interface 400. Dashed circle 430 represents a hover point graphic that may be displayed in response to the presence of object 410 in the hover-space, dashed circle 432 represents a hover point graphic that may be displayed in response to the presence of object 412 in the hover-space, and larger dashed circle 434 represents a hover point graphic that may be displayed in response to the presence of object 414 in the hover-space. The objects 410, 412, and 414 may be characterized based, at least in part, on their actual size or relative sizes. Some multiple hover point gestures may depend on using a finger and a thumb and thus identifying which object is likely the thumb and which is likely the finger may be part of identifying a multiple hover point gesture.

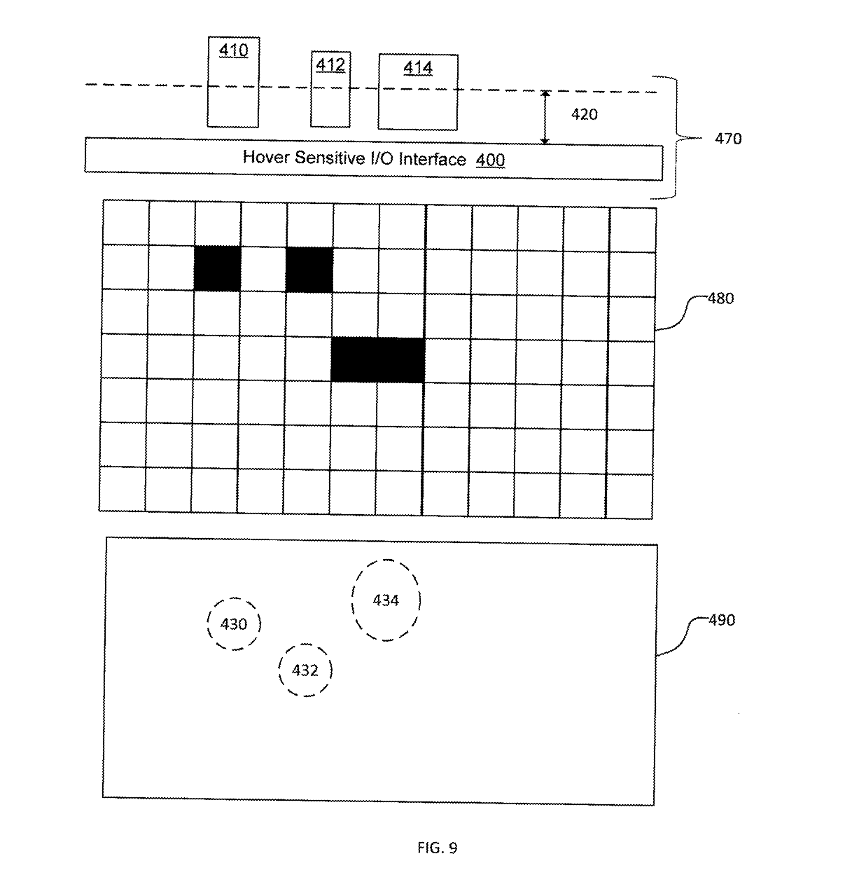

FIG. 9 illustrates actions, objects, and data associated with a multiple hover point gesture. Objects 410, 412, and 414 have moved closer together. The hover points associated with objects 410, 412, and 414 have also moved closer together. Region 490 illustrates that circles 430, 432, and 434 have also moved closer together. If objects 410, 412, and 414 have moved close enough together within a short enough period of time, then the user interface or gesture state may transition to a multi hover point gather gesture detected state. If a user waits too long to move objects 410, 412, and 414 together, or if the objects are not positioned appropriately, then the transition may not occur. Instead, the user interface state or gesture state may transition to a gesture end state. Unlike a pinch where two points are moved together, a multiple hover point gather gesture may be defined by bringing three or more points together. Using two points only allows defining a line. Using three points allows defining an area or a volume. Thus, the three hover points 430, 432, and 434 may define an ellipse, an ellipsoid, or other area or volume. The gather gesture may move objects located in the ellipse together towards a focal point of the ellipse. Which focal point is selected as the gather point may depend, for example, on the relative motion of the points describing the ellipse. When four hover points are used, a rectangular or other space may be described and objects in the rectangular space may be collapsed towards the center of the rectangle. Unlike conventional systems that only operate on objects and that require objects to be in a pinch zone, example apparatus and methods are not so limited. Instead, an example gather gesture may produce a gather control event regardless of whether there are objects displayed anywhere on interface 400, let alone in an area or volume defined by the hover points. Thus, an example multiple hover point gather gesture may be used to control a device, a portion of a device (e.g., speaker, transmitter, radio), an interface, or other device or process independent of what is represented on interface 400. Additionally, unlike conventional systems that can only “release” an object that was pinched using a gesture that at one point required a touch action, an example multiple hover point spread gesture does not require a predecessor touch. For example, a farming game may be configured so that the spread gesture automatically spreads seed or fertilizer without having to first touch a virtual representation of a seed bag or fertilizer bag.

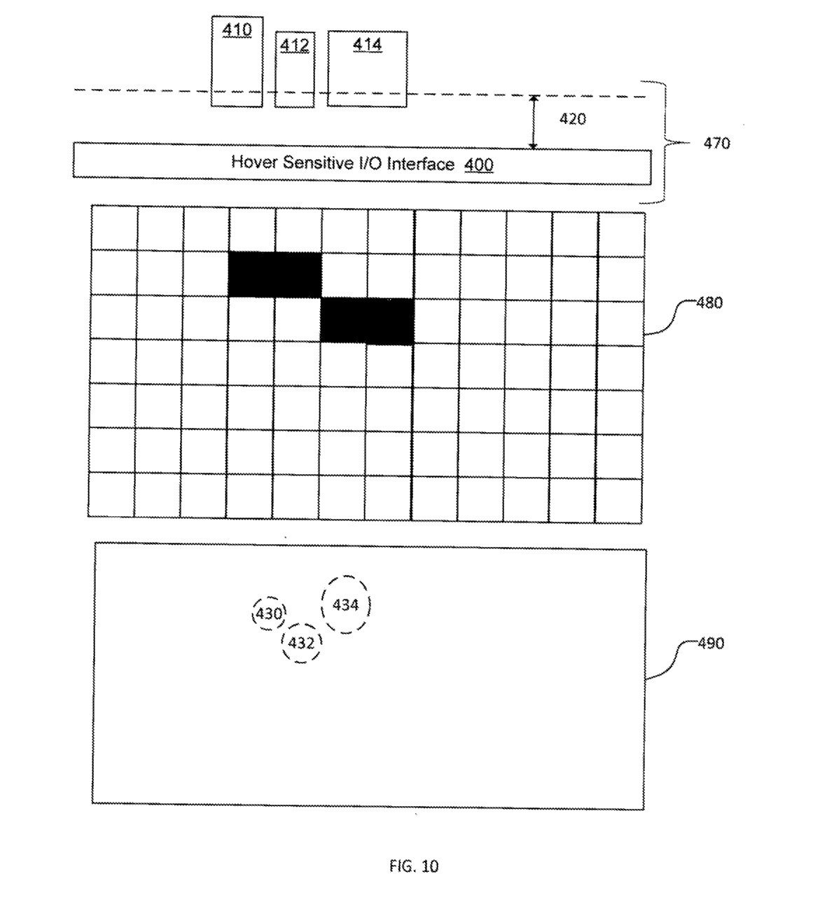

FIG. 10 illustrates actions, objects, and data associated with a multiple hover point gesture. Objects 410, 412, and 414 have moved closer together. Objects 410, 412, and 414 have also moved farther away from the interface 400. The hover points associated with objects 410, 412, and 414 have also moved closer together. Region 490 illustrates that circles 430, 432, and 434 have also moved closer together but have shrunk to represent the movement away from the interface 400.

Not only are the hover points associated with the objects 410, 412, 414, and 416 converging towards a focal point of an ellipse described by the three points, but the points are also retreating from the interface 400. Unlike a conventional system that could only collapse two points together along a line, the three point gather gesture may collect items in an area. Unlike the conventional system that could only operate on one plane, the three point gather gesture may “lift” objects in the z direction at the same time the objects in the ellipse are gathered together. Consider an application that displays photos. A user may wish to collect a set of photos together and place them in a folder. Conventionally, a user may have to select all the photos and then perform a separate action to move the photos. Using the multiple hover point gather gesture with a retreating action, the user may collect the photos and place them in another location in a single gesture. This may reduce memory requirements for a user interface, reduce processing requirements for moving a collection of items, and reduce the time required to perform this action.

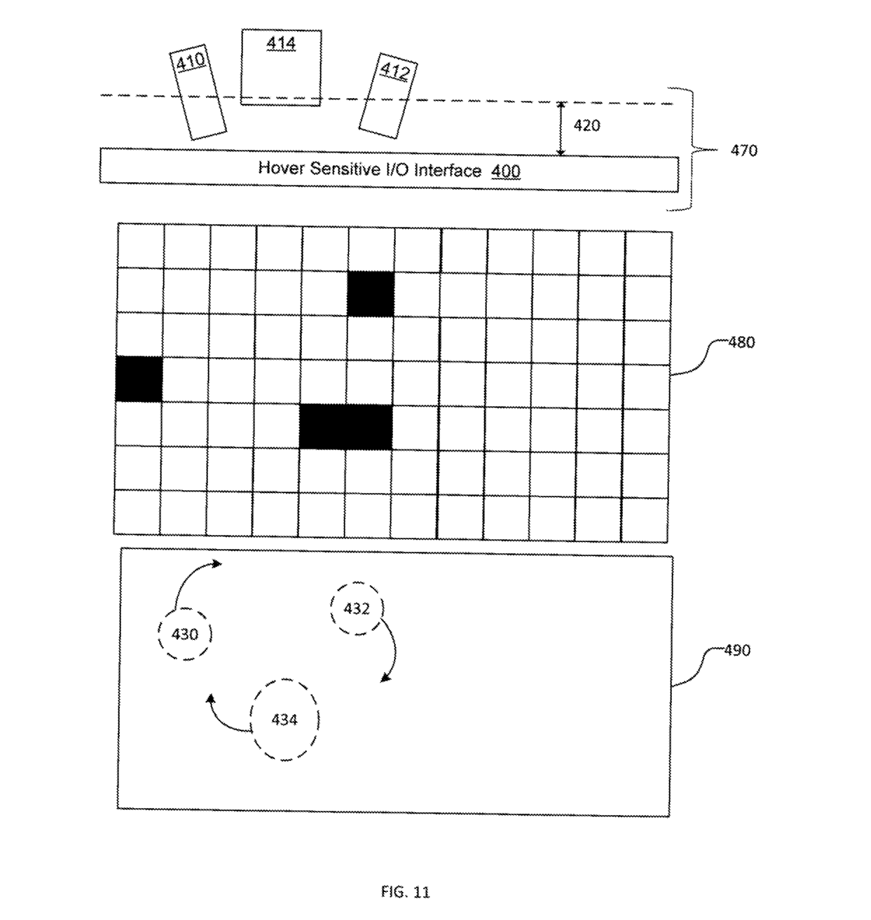

FIG. 11 illustrates actions, objects, and data associated with a multiple hover point crank gesture. Fingers 410 and 412 are located in the hover-space associated with i/o interface 400. Thumb 414 is also located in the hover-space. The hover points 430, 432, and 434 associated with objects 410, 412, and 414 are illustrated in region 490. The objects 410, 412, and 414 may be characterized when they are detected. When the objects 410, 412, and 414 move the movements of hover points 430, 432, and 434 may be tracked. The tracking may be performed in response to hover point move events. If the objects 410, 412, and 414 move in an identifiable pattern, then a gesture may recognized. For example, if the hover points 430, 432, and 434 rotate about a center point or region, then a crank gesture may be identified. The crank gesture may be performed independent of any object to be turned. When the crank gesture is performed parallel to the interface 400, then the gesture may be referred to as a crank gesture. When the crank gesture is performed perpendicular to the interface 400, then the gesture may be referred to as a roll gesture. In one embodiment, when the axis of rotation of the gesture is at an angle of less than forty five degrees from the plane of the interface 400, then the gesture may be referred to as a crank gesture. In one embodiment, when the axis of rotation of the gesture is at an angle of more than forty five degrees from the plane of the interface 400, then the gesture may be referred to as a roll gesture.

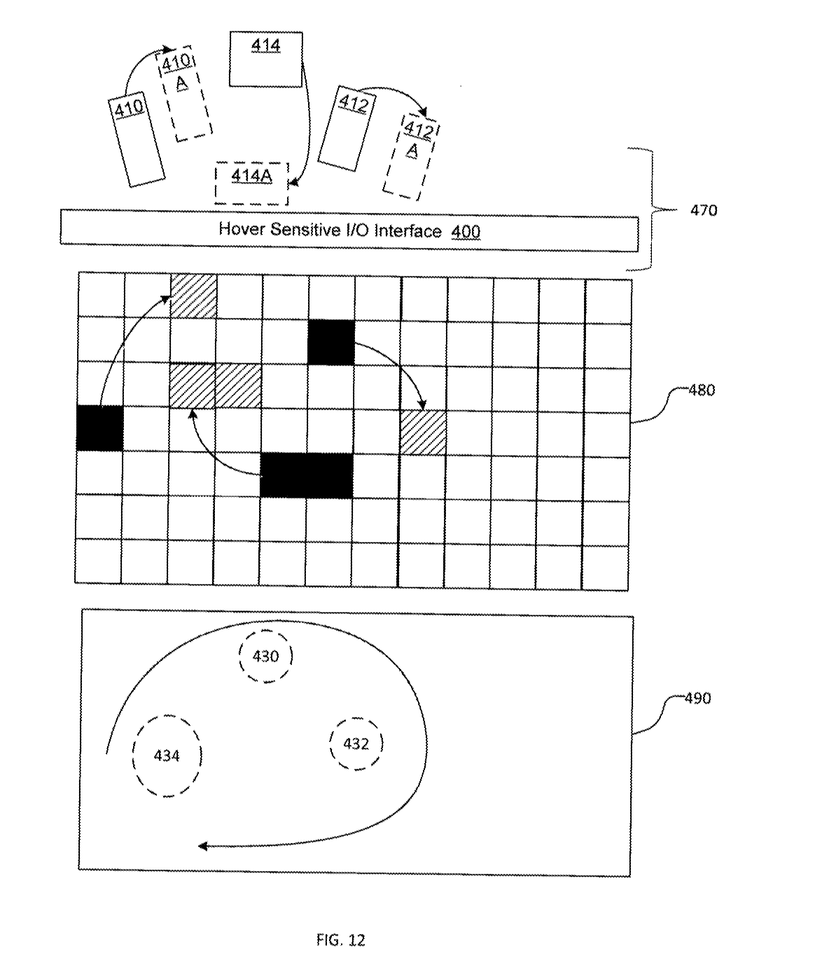

FIG. 12 illustrates movements of objects 410, 412, and 414 that may produce movement in hover points 430, 432, and 434 that may be interpreted as a multiple hover point crank gesture. For example, the movement of object 410 to location 410A, coupled with the similar and temporally-related movement of object 412 to location 412A and object 414 to location 414A may produce a regular, identifiable clockwise rotation of the three points about an axis or central point. When the tracks of the multiple points are related in this way, a multiple hover point crank gesture may be identified. Identifying the gesture may include, for example, identifying paths (e.g., lines, arcs) traveled by the objects and then determining whether the paths are similar to within a threshold and whether the paths were traveled sufficiently concurrently. Control may then be generated in response to the crank gesture. The control may include, for example, increasing the volume of a music player when the crank is clockwise and reducing the volume of the music player when the crank is counter-clockwise. The control may include, for example, twisting the top on or off of a virtual jar displayed on an apparatus, turning a screwdriver in response to the crank gesture, or other rotational control. The control may be exercised without reference to an object displayed on interface 400.

In one embodiment, the z distance of hover points associated with a crank gesture may also be considered. For example, a cranking gesture that is approaching the i/o interface 400 may produce a first control while a cranking gesture that is retreating from the i/o interface 400 may produce a second, different control. For example, in a game where a user is spinning a dreidel, teetotum, or other spinning top, the object being spun may drill down into the surface or may helicopter away from the surface based, at least in part, on whether the crank gesture was approaching or retreating from the i/o interface 400. In one embodiment, the crank gesture may be part of a ratchet gesture. For example, after cranking to the right at a first speed that exceeds a speed threshold, a user may return their fingers to the left at a second slower speed that does not exceed the speed threshold. The user may then repeat cranking to the right at the first faster speed and returning to the left at the second slower speed. In this gesture, not only the movement of the fingers but also the speed at which the fingers move determines the gesture. Like an actual ratchet device (e.g., socket wrench), the ratchet gesture may be used to perform multiple turns on an object with only turns in one direction being applied to the object, the turns in the opposite direction being ignored. In one embodiment, the ratchet gesture may be achieved by varying the speed at which the fingers perform the crank gesture. In another embodiment, the ratchet gesture may be achieved by varying the width of the fingers during the crank. For example, when the fingers are at a first narrower distance (e.g., 1 cm) the crank may be applied to an object while when the fingers are returning at a second wider distance (e.g., 5 cm) the crank may not be applied.

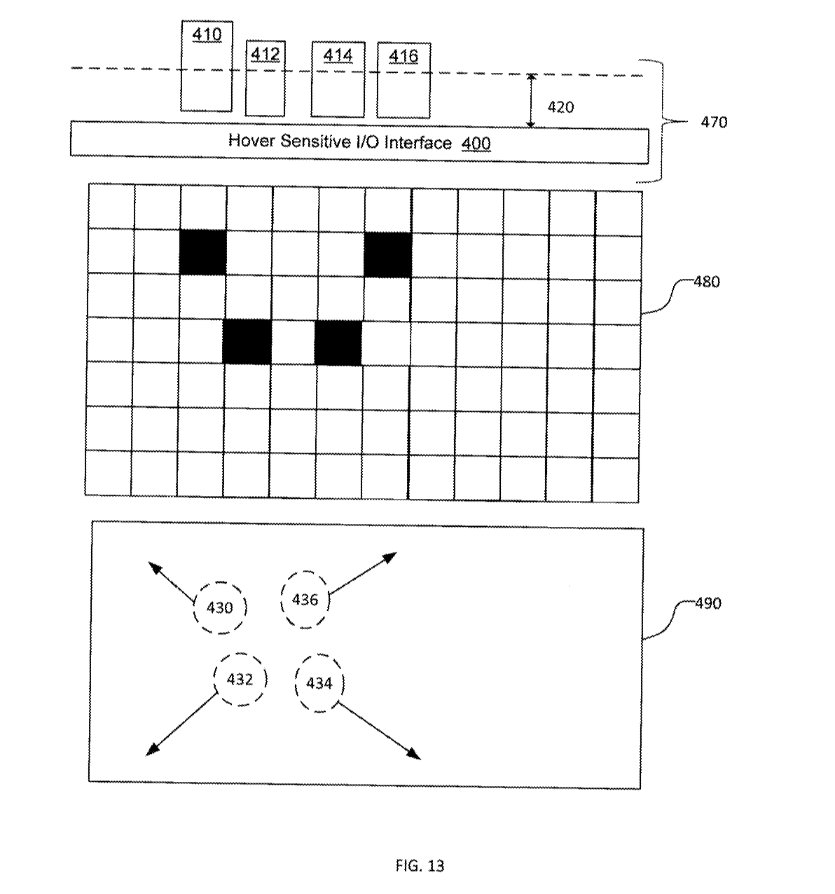

FIG. 13 illustrates actions, objects, and data associated with a multiple hover point spread gesture. Objects 410, 412, 414, and 416 are all located in the hover zone associated with hover sensitive i/o interface 400. The objects 410, 412, 414, and 416 are all located close to the interface 400. Region 480 illustrates the hover points associated with the objects 410, 412, 414, and 416 and region 490 illustrates dashed circles 430, 432, 434, and 436 displayed in response to the presence of the objects 410, 412, 414, and 416. The arrows in region 490 indicate that the circles 430, 432, 434, and 436 are moving outwards in response to objects 410, 412, 414, and 416 moving outwards. Unlike a conventional two finger touch gesture that can only spread two points on a line, example apparatus and methods facilitate spreading a two dimensional area or a three dimensional volume. In one embodiment, if objects 410, 412, 414, and 416 spread out but stayed at the same distance from i/o interface 400, then an area displayed by the apparatus may increase. In another embodiment, if objects 410, 412, 414, and 416 spread out and move away from the i/o interface 400, then a volume (e.g., sphere, apple, house, bubble) displayed by the apparatus may increase. Being able to identify an area or a volume may provide richer experiences in, for example, video gaming where a spell may have an area effect or volume effect. Rather than having to describe an area using a mouse or by clicking on three points, a user may simply spread their fingers over the area or volume they wish to have covered by the spell. Similarly, being able to identify two different types of expansion or contraction at the same time may be employed in musical applications where, for example, both the volume and the reverb of a sound may be changed. In one embodiment, when a retreating spread gesture is combined with a crank gesture, volume, reverb, and another attribute (e.g., number of different sounds to be included in a chord) may all be manipulated simultaneously. Note that the area effect spell, volume and reverb, and crank actions can be applied without a predecessor touch and independently of an object displayed on an apparatus.

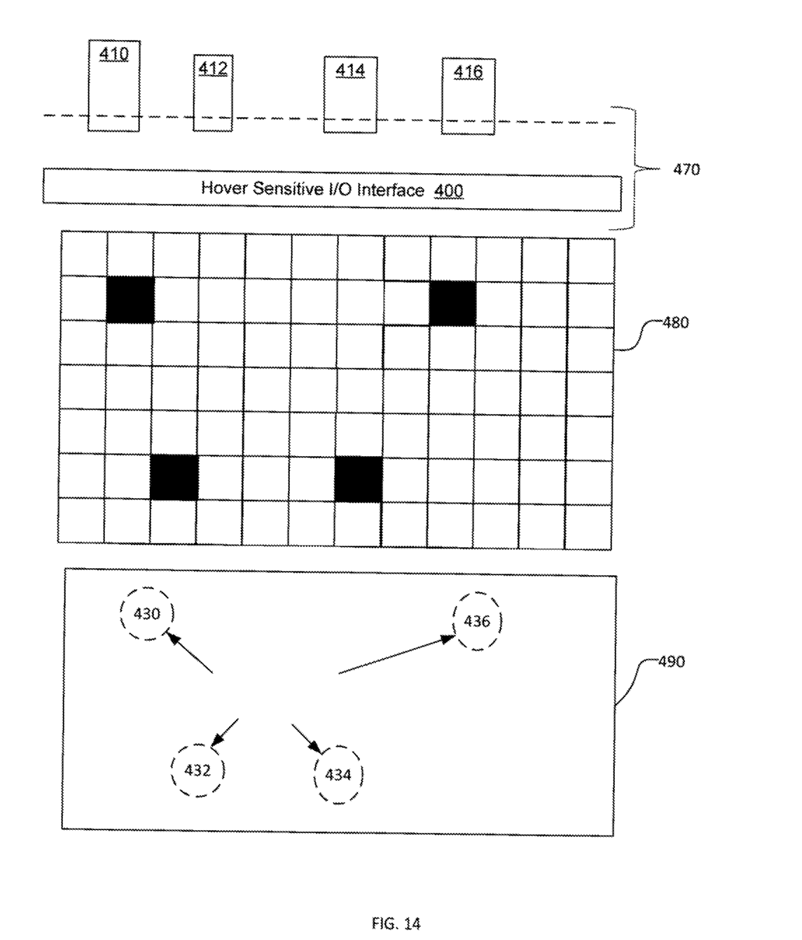

FIG. 14 illustrates actions, objects, and data associated with a multiple hover point spread gesture. Objects 410, 412, 414, and 416 have spread apart and have moved away from interface 400. Circles 430, 432, 434, and 436 have also spread apart. When multiple hover points move apart in a similar way within a threshold period of time, then a multiple hover point spread action may be identified. When the action is identified, an event may be generated. Or, the action may be identified in response to an event being handled. Control associated with the spread gesture may then be applied. For example, performing a spread gesture over a wireless enabled device may cause the device to switch into a transmit mode while performing a gather gesture over the device may cause the device to switch out of the transmit mode. Performing a spread gesture over a map may cause a zoom in while performing a gather gesture may cause a zoom out. In an art application, performing a spread gesture over a color may blend the color into the area covered by the spread gesture. In a photographic fun game, performing a spread gesture over a portion of a photograph may cause the portion of the photograph covered by the spread to distort itself to a larger shape. Performing a retreating spread may cause the distortion to look like it has occurred in three dimensions where the image is distorted to a larger shape and pulled toward the viewer.

While multiple hover point gestures including a gather, spread, and crank have been described, and while both approaching and retreating variations of these gestures have been described, other multiple hover point gestures are possible. For example, a multiple hover point sling shot gesture may be performed by pinching two fingers together and then moving the pinched fingers away from the initial pinch point to a release point. The displacement in the x, y, or z directions may control the velocity, angle, and direction at which an object that was pulled back in the sling shot may be propelled in a virtual world over which the gesture was performed.

More generally, example apparatus and methods may detect multiple hover points, characterize those multiple hover points, track the hover points, and identify a gesture from the characterization and tracking data. Control may then be exercised based on the gesture that is identified and the movements of the multiple hover points. The control may be based on factors including, but not limited to, the direction(s) in which the hover points move, the rate(s) at which the hover points move, the co-ordination between the multiple hover points, the duration of the gesture, and other factors. In one embodiment, the multiple hover point gestures do not involve a touch, a camera, or any particular item being displayed on an interface with which the gesture is performed.

Some portions of the detailed descriptions that follow are presented in terms of algorithms and symbolic representations of operations on data bits within a memory. These algorithmic descriptions and representations are used by those skilled in the art to convey the substance of their work to others. An algorithm is considered to be a sequence of operations that produce a result. The operations may include creating and manipulating physical quantities that may take the form of electronic values. Creating or manipulating a physical quantity in the form of an electronic value produces a concrete, tangible, useful, real-world result.

It has proven convenient at times, principally for reasons of common usage, to refer to these signals as bits, values, elements, symbols, characters, terms, numbers, and other terms. It should be borne in mind, however, that these and similar terms are to be associated with the appropriate physical quantities and are merely convenient labels applied to these quantities. Unless specifically stated otherwise, it is appreciated that throughout the description, terms including processing, computing, and determining, refer to actions and processes of a computer system, logic, processor, or similar electronic device that manipulates and transforms data represented as physical quantities (e.g., electronic values).

Example methods may be better appreciated with reference to flow diagrams. For simplicity, the illustrated methodologies are shown and described as a series of blocks. However, the methodologies may not be limited by the order of the blocks because, in some embodiments, the blocks may occur in different orders than shown and described. Moreover, fewer than all the illustrated blocks may be required to implement an example methodology. Blocks may be combined or separated into multiple components. Furthermore, additional or alternative methodologies can employ additional, not illustrated blocks.

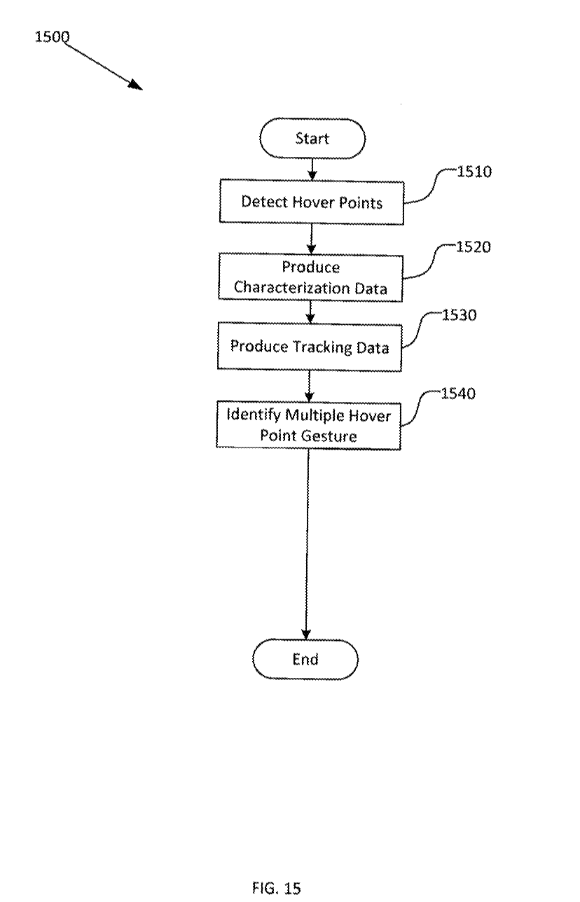

FIG. 15 illustrates an example method 1500 associated with multiple hover point gestures performed with respect to an apparatus having an input/output display that is hover-sensitive. Method 1500 may include, at 1510, detecting a plurality of hover points in the hover-space associated with the hover sensitive input/output interface. Individual objects in the hover space may be assigned their own hover point. In one embodiment, the plurality of hover points may include up to ten hover points. In another embodiment, the plurality of hover points may be associated with a combination of human anatomy (e.g., fingers) and apparatus (e.g., stylus). Recall that conventional systems relied on cameras or touch sensors. In one embodiment, detecting the plurality of hover points is performed without using a camera or a touch sensor. Instead, hover points are detected using non-camera based proximity sensors that do not need an initiating touch.

Different objects may have different positions, sizes, and movements. Therefore, method 1500 may also include, at 1520, producing independent characterization data for members of the plurality of hover points. In one embodiment, the characterization data for a member of the plurality of hover points describes an (x, y, z) position in the hover-space. Position is one attribute of an object in the hover space. Size is another attribute of an object. Therefore, in one embodiment, the characterization data may also include an x length measurement of the object and a y length measurement of the object. Gestures involve motion. However, a gesture may not involve constant motion. For example, in a sling shot gesture, the pinch and pull portion may be separated from a release portion by a pause while a user lines up their shot. Thus, in one embodiment, the characterization data may also include an amount of time the member has been at the x position, an amount of time the member has been at the y position, and an amount of time the member has been at the z position. If the time exceeds a threshold, then a gesture may not be detected. Some gestures are defined as involving just fingers, a single finger and a single thumb, or other combinations of digits, stylus, or other object. Therefore, in one embodiment, the characterization data may also include data describing the likelihood that the member is a finger, data describing the likelihood that the member is a thumb, or data describing the likelihood that the member is a portion of a hand other than a finger or thumb.

In one embodiment, the characterization data is produced without using a camera or a touch sensor. Additionally, the characterization data may be produced without reference to an object displayed on the apparatus. Thus, unlike conventional systems where a user touches an object on a screen and then performs a hover gesture on the selected item, method 1500 may proceed without a touch on the screen and without relying on any particular item being displayed on the screen. This facilitates, for example, controlling volume or brightness without having to consume display space with a volume control or brightness control.

A gesture involves motion. Therefore, method 1500 may also include, at 1530, producing independent tracking data for members of the plurality of hover points. The tracking data facilitates determining whether the objects, and thus the hover points associated with the objects have moved in identifiable correlated patterns associated with a specific multiple hover point gesture.

In one embodiment, the tracking data for a member of the plurality of hover points describes an (x, y, z) position in the hover-space for the member. The tracking data is not only concerned with where an object is located, but also with where the hover point has been, how quickly the hover point is moving, and how long the hover point has been moving. Thus, in one embodiment, the tracking data may include a measurement of how much the hover point has moved in the x, y, or z direction, and a rate at which the hover point is moving in the x, y, or z direction. The tracking data may also include a measurement of how long the hover point has been moving in the x direction, the y direction, or the z direction. The rate at which a hover point is moving may be used to allow the gesture to operate in four dimensions (e.g., x, y, z, time). For example, a crank gesture may be used to turn an object, or, more generally, to exert rotational control. The amount of time for which the rotational control will be exercised may be a function of the rate at which the hover points move during the gesture.

Conventional systems may have tracked single hover points for simple gestures. Example methods and apparatus may track multiple hover points for more complicated gestures. The more complicated gestures involve coordinated movement by two or more objects. Thus, the tracking data for a hover point may describe a degree of correlation between how the hover point has been moving and how other hover points have been moving. For example, the tracking data may store information that a first hover point has moved linearly a certain amount and in a certain direction during a time window. The tracking data may also store information that a second hover point has moved linearly a certain amount and in a certain direction during the time window. The tracking data may also store information that the first and second hover point have moved a similar distance in a similar direction in the time window. Or the tracking data may store information that the first and second hover point have moved a similar distance in opposite directions in the time window.

Like the hover points are detected without using a camera or touch sensor, the tracking data may be produced without using a camera or a touch sensor. Unlike conventional systems that are designed to only manipulate objects that are displayed on a device, the tracking data may be produced without reference to an object displayed on the apparatus. Thus, the tracking data may be used to identify multiple hover point gestures that will control the apparatus as a whole, a subsystem of the apparatus, or a process running on the apparatus, rather than just an object displayed on the apparatus.

Method 1500 may also include, at 1540, identifying a multiple hover point gesture based, at least in part, on the characterization data and the tracking data. A multiple hover point gesture like a crank involves the coordinated movement of, for example, two fingers and a thumb. The movements may be simultaneous rotational motion around an axis. In different embodiments, the multiple hover point gesture may be a gather gesture, a spread gesture, a crank gesture, a roll gesture, a ratchet gesture, a poof gesture, or a sling shot gesture. Other gestures may be identified. The identification may involve determining that a threshold number of objects have moved in identifiable related paths within a threshold period of time. For example, for the gather gesture, two, three, or more objects may have to move towards a gather point along substantially linear paths that would intersect. For the spread gesture, two, three, or more objects may have to move outwards from a distribution point along substantially linear paths would not intersect. For a poof gesture, two coordinated spread gestures may need to be performed by two separate sets of hover points. For example, a user may need to perform a spread gesture with both the right hand and the left hand, at the same time, and at a sufficient rate, to generate the poof gesture.

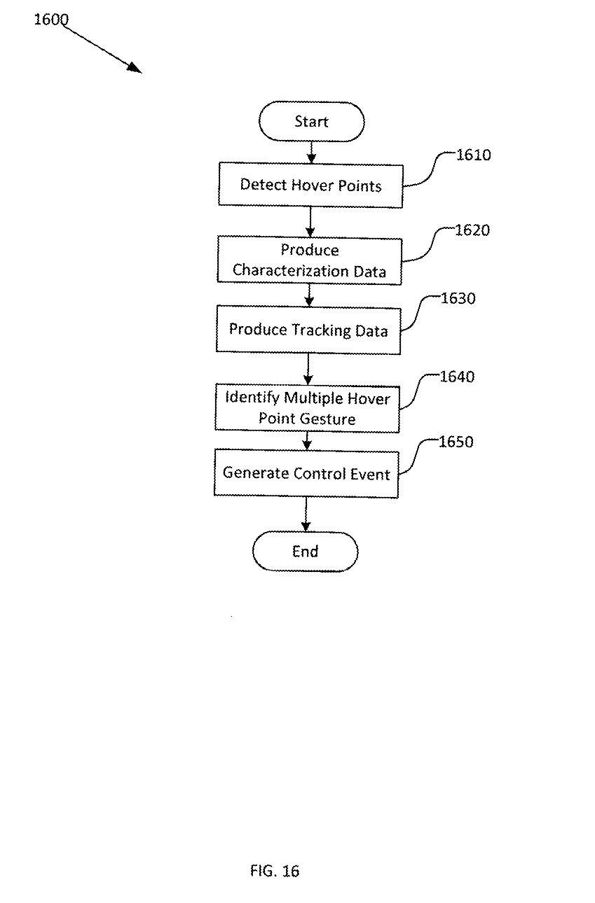

FIG. 16 illustrates an example method 1600 that is similar to method 1500 (FIG. 15). For example, method 1600 includes detecting a plurality of hover points at 1610, producing characterization data at 1620, producing tracking data at 1630, and identifying a multiple hover point gesture at 1640. However, method 1600 also includes an additional action. In one embodiment, method 1600 may include, at 1650, generating a control event based on the multiple hover point gesture. The control event may be directed to the apparatus as a whole, to a subsystem (e.g., speaker) on the apparatus, to a device that the apparatus controls (e.g., game console), to a process running on the apparatus, or to other controlled entities. In different embodiments, the control event may control whether the apparatus is turned on or off or control whether a portion of the apparatus is turned on or off. In one embodiment, the control event may control a volume associated with the apparatus or a brightness associated with the apparatus. In one embodiment, the control event may control whether a transmitter associated with the apparatus is turned on or off, whether a receiver associated with the apparatus is turned on or off, or whether a transceiver associated with the apparatus is turned on or off. Note that these control events are not associated with any item displayed on the apparatus. Note also that these control events do not involve touch interactions with the apparatus. Even though the control event can exercise control independent of an object displayed by the device, in one embodiment, the control event may control the appearance of an object displayed on the apparatus. Generating a control event may include, for example, writing a value to a memory or register, producing a voltage in a line, generating an interrupt, making a procedure call through a remote procedure call portal, or other action.

While FIGS. 15 and 16 illustrate various actions occurring in serial, it is to be appreciated that various actions illustrated in FIGS. 15 and 16 could occur substantially in parallel. By way of illustration, a first process could handle events, a second process could generate events, and a third process could exercise control over an apparatus, process, or portion of an apparatus in response to the events. While three processes are described, it is to be appreciated that a greater or lesser number of processes could be employed and that lightweight processes, regular processes, threads, and other approaches could be employed.

In one example, a method may be implemented as computer executable instructions. Thus, in one example, a computer-readable storage medium may store computer executable instructions that if executed by a machine (e.g., computer) cause the machine to perform methods described or claimed herein including methods 1500 or 1600. While executable instructions associated with the listed methods are described as being stored on a computer-readable storage medium, it is to be appreciated that executable instructions associated with other example methods described or claimed herein may also be stored on a computer-readable storage medium. In different embodiments, the example methods described herein may be triggered in different ways. In one embodiment, a method may be triggered manually by a user. In another example, a method may be triggered automatically.

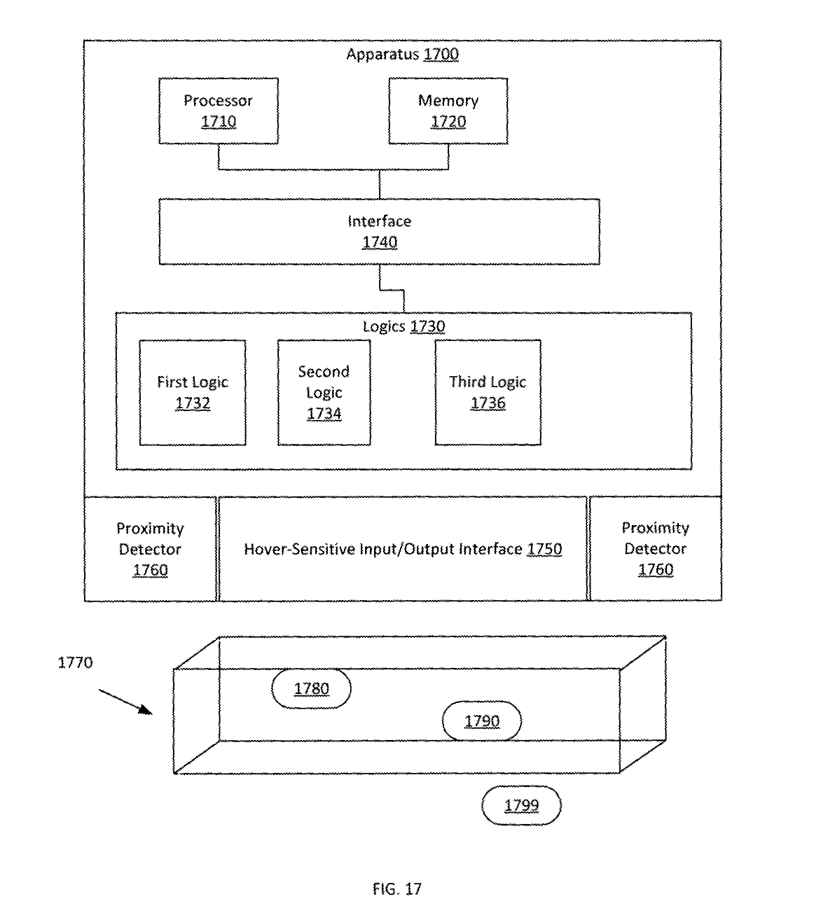

FIG. 17 illustrates an apparatus 1700 that supports event driven processing for gestures involving multiple hover points. In one example, the apparatus 1700 includes an interface 1740 configured to connect a processor 1710, a memory 1720, a set of logics 1730, a proximity detector 1760, and a hover-sensitive i/o interface 1750. Elements of the apparatus 1700 may be configured to communicate with each other, but not all connections have been shown for clarity of illustration. The hover-sensitive input/output interface 1750 may be configured to display an item that can be manipulated by a multiple hover point gesture. The set of logics 1730 may be configured to manipulate the state of the item in response to multiple hover point gestures. In one embodiment, apparatus 1700 may handle hover gestures independent of there being an item displayed on input/output interface 1750.

The proximity detector 1760 may detect an object 1780 in a hover-space 1770 associated with the apparatus 1700. The proximity detector 1760 may also detect another object 1790 in the hover-space 1770. In one embodiment, the proximity detector 1760 may detect, characterize, and track multiple objects in the hover-space simultaneously. The hover-space 1770 may be, for example, a three dimensional volume disposed in proximity to the i/o interface 1750 and in an area accessible to the proximity detector 1760. The hover-space 1770 has finite bounds. Therefore the proximity detector 1760 may not detect an object 1799 that is positioned outside the hover-space 1770. A user may place a digit in the hover-space 1770, may place multiple digits in the hover-space 1770, may place their hand in the hover-space 1770, may place an object (e.g., stylus) in the hover-space, may make a gesture in the hover-space 1770, may remove a digit from the hover-space 1770, or take other actions. The entry of an object into hover-space 1770 may produce a hover-enter event. The exit of an object from hover-space 1770 may produce a hover-exit event. The movement of an object in hover-space 1770 may produce a hover-move event. Example methods and apparatus may interact with (e.g., handle) these hover events.

Apparatus 1700 may include a hover-sensitive input/output interface 1750. The hover-sensitive input/output interface 1750 may be configured to produce a hover event associated with an object in a hover-space associated with the hover-sensitive input/output interface 1750. The hover event may be, for example, a hover enter event that identifies that an object has entered the hover space and describes the position, size, trajectory or other information associated with the object.

Apparatus 1700 may include a first logic 1732 that is configured to handle the hover event. The hover event may be detected in response to a signal provided by the hover-sensitive input/output interface 1750, in response to an interrupt generated by the input/output interface 1750, in response to data written to a memory, register, or other location by the input/output interface 1750, or in other ways. Thus, handling the hover event involves automatically detecting a change in a physical item.

In one embodiment, the first logic 1732 handles the hover event by generating data for the object that caused the hover event. The data may include, for example, position data, path data, and tracking data. In one embodiment, the position data may be (x, y, z) coordinate data for the object that caused the hover event. In one embodiment, the position data may be angle and distance data that relates the object to a reference point associated with the device. In one embodiment, the position data may include relationships between objects in the hover space.

The tracking data may describe where the object that produced the hover point has been. In one embodiment, the tracking data may include a linked list or other organized collection of points at which the object that produced the hover event has been located. In one embodiment, the tracking data may include a function that describes the trajectory taken by the object that produced the hover event. The function may be described using, for example, plane geometry, solid geometry, spherical geometry, or other models. In one embodiment, the tracking data may include a reference to other tracks taken by other objects in the hover space. The path data may describe where the object that produced the hover point is likely headed. In one embodiment, the path data may include a set of projected points that the hover point may visit based, at least in part, on where the hover point is, where the hover point has been, and the rate at which the hover point is moving. In one embodiment, the path data may include a function that describes the trajectory likely to be taken by the object that produced the hover event. The function may be described using, for example, plane geometry, solid geometry, spherical geometry, or other models.

Apparatus 1700 may include a second logic 1734 that is configured to detect a multiple hover point gesture. A multiple hover point gesture involves at least two hover points, where at least one of the hover points moves. Since apparatus 1700 is using an event driven approach, the second logic 1734 may detect the multiple hover point gesture based, at least in part, on hover events generated by objects in the hover-space. For example, a set of hover enter events followed by a series of hover move events that produce data that describe related paths and tracks within a threshold period of time may yield a multiple hover point gesture detection. The event driven approach differs from conventional camera based approaches that perform image processing. The event driven approach also differs from conventional systems that perform constant control detecting or tracking. Rather than busy waiting for motion or wasting resources on an object that is not moving, the event driven approach may conserve resources by responding to motion.

In one embodiment, the second logic 1734 detects a multiple hover point gesture by correlating movements between the two or more objects. In one embodiment, the movements are correlated as a function of analyzing the position data, the path data, or the tracking data. A user may be using two different fingers to perform two different functions on a device. For example, a user may be using their right index finger to scroll through a list and may be using their left index finger to control a zoom factor. Although the two fingers may both be producing events, the events are unrelated. A multiple hover point gesture involves coordinated action by two or more objects (e.g., fingers). Thus, the second logic 1734 may identify movements that happen within a gesture time window and then determine whether the movements are related. For example, the second logic 1734 may determine whether the objects are moving on intersecting paths, whether the objects are moving on diverging paths that would intersect if traveled in the opposite direction, whether the objects are moving in a curved path around a common axis or region, or other relationship. When relationships are discovered, the second logic 1734 may detect the multiple hover point gesture.

Apparatus 1700 may include a third logic 1736 that is configured to generate a control event associated with the multiple hover point gesture. The control event may describe, for example, the gesture that was performed. Thus, the control event may be, for example, a gather event, a spread event, a crank event, a roll event, a ratchet event, a poof event, or a slingshot event. Generating the control event may include, for example, writing a value to a memory or register, producing a voltage in a line, generating an interrupt, making a procedure call through a remote procedure call portal, or other action. The control event may be applied to the apparatus 1700 as a whole, to a portion of the apparatus 1700, or to another device being managed or controlled by apparatus 1700. Thus, the control event may be configured to control the apparatus, a radio associated with the apparatus, a social media circle associated with a user of the apparatus, a transmitter associated with the apparatus, a receiver associated with the apparatus, or a process being performed by the apparatus. By way of illustration, a spread gesture may be used to control the breadth of the social circle to which a text message is to be sent. A fast wide spread gesture may send the text to the public while a slow narrow spread gesture may only send the text message to close friends.

Unlike conventional systems that rely on touches or cameras, the first logic 1732, the second logic 1734, and the third logic 1736 may operate without referencing touch sensor data and without referencing camera data.

Apparatus 1700 may include a memory 1720. Memory 1720 can include non-removable memory or removable memory. Non-removable memory may include random access memory (RAM), read only memory (ROM), flash memory, a hard disk, or other memory storage technologies. Removable memory may include flash memory, or other memory storage technologies, such as “smart cards.” Memory 1720 may be configured to store user interface state information, characterization data, object data, data about the item, data about a multiple hover point gesture, data about a hover event, data about a gesture event, data associated with a state machine, or other data.

Apparatus 1700 may include a processor 1710. Processor 1710 may be, for example, a signal processor, a microprocessor, an application specific integrated circuit (ASIC), or other control and processing logic circuitry for performing tasks including signal coding, data processing, input/output processing, power control, or other functions. Processor 1710 may be configured to interact with logics 1730 that handle multiple hover point gestures.

In one embodiment, the apparatus 1700 may be a general purpose computer that has been transformed into a special purpose computer through the inclusion of the set of logics 1730. The set of logics 1730 may be configured to perform input and output. Apparatus 1700 may interact with other apparatus, processes, and services through, for example, a computer network.

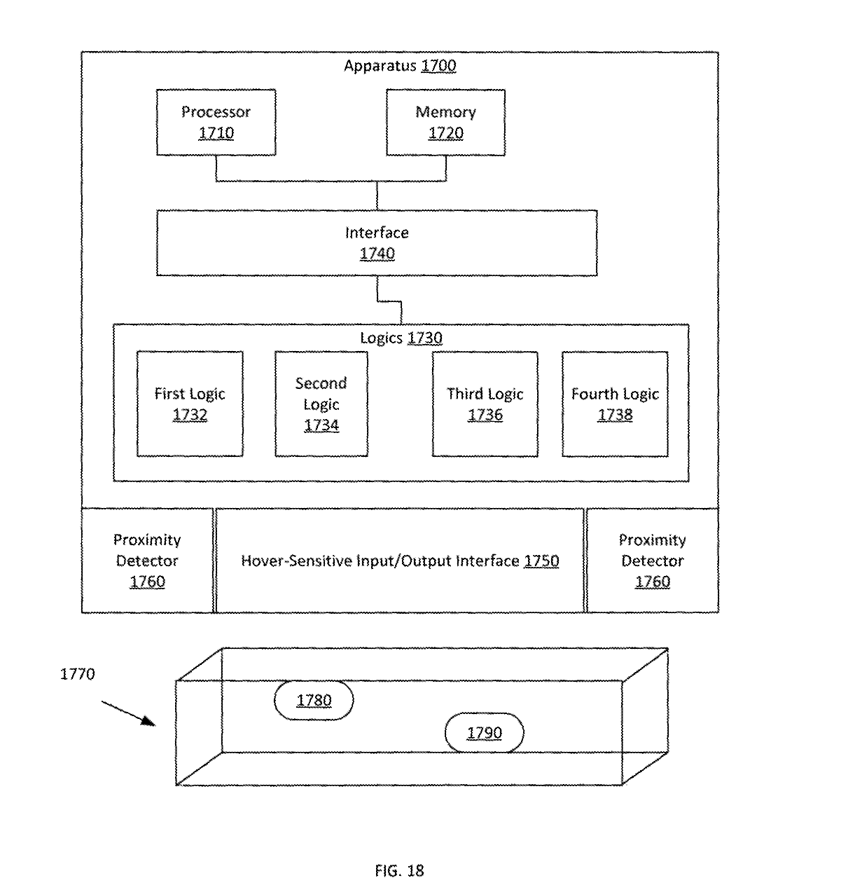

FIG. 18 illustrates another embodiment of apparatus 1700 (FIG. 17). This embodiment of apparatus 1700 includes a fourth logic 1738 that is configured to manage a state machine associated with the multiple hover point gesture, where managing the state machine includes transitioning a process or data structure from a first multiple hover point state to a second, different multiple hover point state in response to detecting a portion of a multiple hover point gesture. In one embodiment, the state machine may include an object that stores data about the progress made in identifying or handling a multiple hover point gesture. In one embodiment, the state machine may include a set of objects with different objects associated with the different states. The state machine may include an event handler that catches hover events or gesture events as they are generated and that updates the data, memory, objects, or processes associated with the gesture.

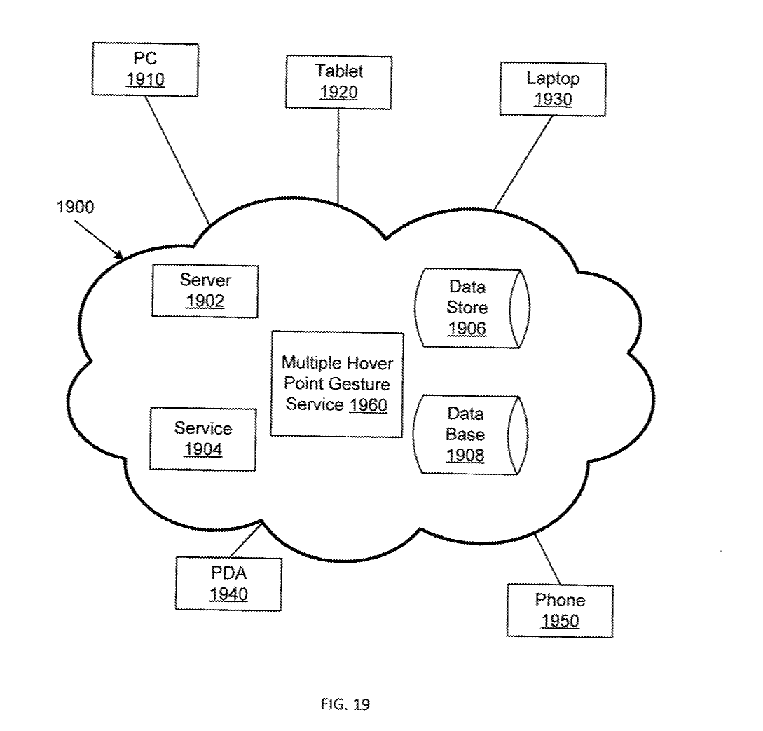

FIG. 19 illustrates an example cloud operating environment 1900. A cloud operating environment 1900 supports delivering computing, processing, storage, data management, applications, and other functionality as an abstract service rather than as a standalone product. Services may be provided by virtual servers that may be implemented as one or more processes on one or more computing devices. In some embodiments, processes may migrate between servers without disrupting the cloud service. In the cloud, shared resources (e.g., computing, storage) may be provided to computers including servers, clients, and mobile devices over a network. Different networks (e.g., Ethemet, Wi-Fi, 802.x, cellular) may be used to access cloud services. Users interacting with the cloud may not need to know the particulars (e.g., location, name, server, database) of a device that is actually providing the service (e.g., computing, storage). Users may access cloud services via, for example, a web browser, a thin client, a mobile application, or in other ways.

FIG. 19 illustrates an example multiple hover point gesture service 1960 residing in the cloud. The multiple hover point gesture service 1960 may rely on a server 1902 or service 1904 to perform processing and may rely on a data store 1906 or database 1908 to store data. While a single server 1902, a single service 1904, a single data store 1906, and a single database 1908 are illustrated, multiple instances of servers, services, data stores, and databases may reside in the cloud and may, therefore, be used by the multiple hover point gesture service 1960.

FIG. 19 illustrates various devices accessing the multiple hover point gesture service 1960 in the cloud. The devices include a computer 1910, a tablet 1920, a laptop computer 1930, a personal digital assistant 1940, and a mobile device (e.g., cellular phone, satellite phone) 1950. It is possible that different users at different locations using different devices may access the multiple hover point gesture service 1960 through different networks or interfaces. In one example, the multiple hover point gesture service 1960 may be accessed by a mobile device (e.g., phone 1950). In another example, portions of multiple hover point gesture service 1960 may reside on a phone 1950. Multiple hover point gesture service 1960 may perform actions including, for example, producing events, handling events, updating a display, recording events and corresponding display updates, or other action. In one embodiment, multiple hover point gesture service 1960 may perform portions of methods described herein (e.g., method 1500, method 1600).

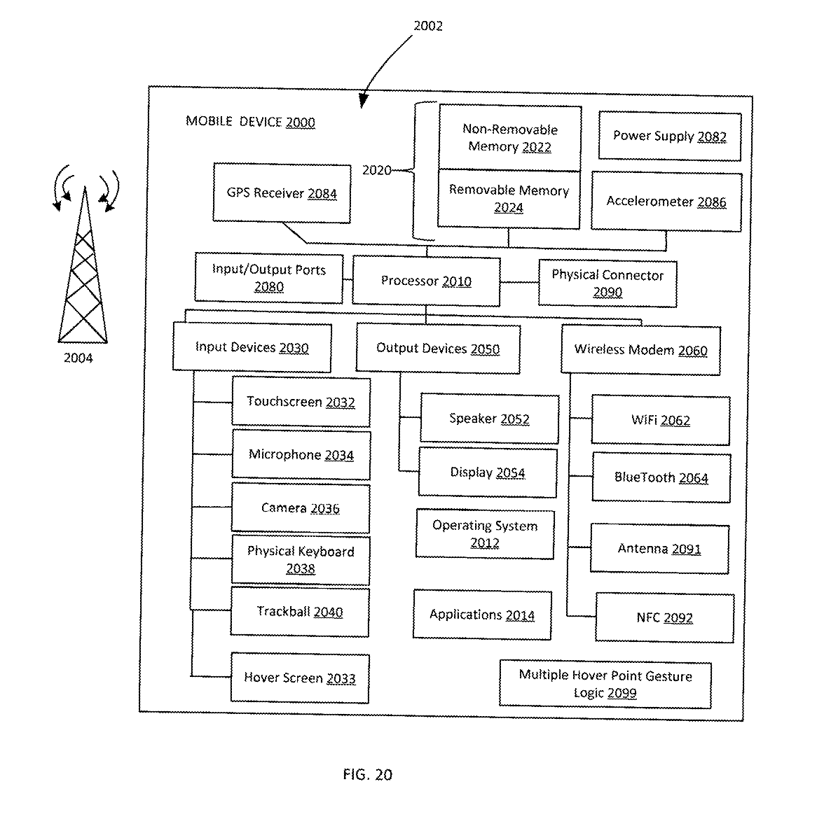

FIG. 20 is a system diagram depicting an exemplary mobile device 2000 that includes a variety of optional hardware and software components, shown generally at 2002. Components 2002 in the mobile device 2000 can communicate with other components, although not all connections are shown for ease of illustration. The mobile device 2000 may be a variety of computing devices (e.g., cell phone, smartphone, handheld computer, Personal Digital Assistant (PDA), etc.) and may allow wireless two-way communications with one or more mobile communications networks 2004, such as a cellular or satellite networks.

Mobile device 2000 can include a controller or processor 2010 (e.g., signal processor, microprocessor, application specific integrated circuit (ASIC), or other control and processing logic circuitry) for performing tasks including signal coding, data processing, input/output processing, power control, or other functions. An operating system 2012 can control the allocation and usage of the components 2002 and support application programs 2014. The application programs 2014 can include mobile computing applications (e.g., email applications, calendars, contact managers, web browsers, messaging applications), gesture handling applications, or other computing applications.

Mobile device 2000 can include memory 2020. Memory 2020 can include non-removable memory 2022 or removable memory 2024. The non-removable memory 2022 can include random access memory (RAM), read only memory (ROM), flash memory, a hard disk, or other memory storage technologies. The removable memory 2024 can include flash memory or a Subscriber Identity Module (SIM) card, which is known in GSM communication systems, or other memory storage technologies, such as “smart cards.” The memory 2020 can be used for storing data or code for running the operating system 2012 and the applications 2014. Example data can include hover point data, user interface element state, web pages, text, images, sound files, video data, or other data sets to be sent to or received from one or more network servers or other devices via one or more wired or wireless networks. The memory 2020 can store a subscriber identifier, such as an International Mobile Subscriber Identity (IMSI), and an equipment identifier, such as an International Mobile Equipment Identifier (IMEI). The identifiers can be transmitted to a network server to identify users or equipment.

The mobile device 2000 can support one or more input devices 2030 including, but not limited to, a touchscreen 2032, a hover screen 2033, a microphone 2034, a camera 2036, a physical keyboard 2038, or trackball 2040. The mobile device 2000 may also support output devices 2050 including, but not limited to, a speaker 2052 and a display 2054. Other possible input devices (not shown) include accelerometers (e.g., one dimensional, two dimensional, three dimensional). Other possible output devices (not shown) can include piezoelectric or other haptic output devices. Some devices can serve more than one input/output function. For example, touchscreen 2032 and display 2054 can be combined in a single input/output device.

The input devices 2030 can include a Natural User Interface (NUI). An NUI is an interface technology that enables a user to interact with a device in a “natural” manner, free from artificial constraints imposed by input devices such as mice, keyboards, remote controls, and others. Examples of NUI methods include those relying on speech recognition, touch and stylus recognition, gesture recognition (both on screen and adjacent to the screen), air gestures, head and eye tracking, voice and speech, vision, touch, gestures, and machine intelligence. Other examples of a NUI include motion gesture detection using accelerometers/gyroscopes, facial recognition, three dimensional (3D) displays, head, eye, and gaze tracking, immersive augmented reality and virtual reality systems, all of which provide a more natural interface, as well as technologies for sensing brain activity using electric field sensing electrodes (electro-encephalogram (EEG) and related methods). Thus, in one specific example, the operating system 2012 or applications 2014 can comprise speech-recognition software as part of a voice user interface that allows a user to operate the device 2000 via voice commands. Further, the device 2000 can include input devices and software that allow for user interaction via a user's spatial gestures, such as detecting and interpreting gestures to provide input to an application. In one embodiment, the multiple hover point gesture may be recognized and handled by, for example, changing the appearance or location of an item displayed on the device 2000.

A wireless modem 2060 can be coupled to an antenna 2091. In some examples, radio frequency (RF) fitters are used and the processor 2010 need not select an antenna configuration for a selected frequency band. The wireless modem 2060 can support two-way communications between the processor 2010 and external devices. The modem 2060 is shown generically and can include a cellular modem for communicating with the mobile communication network 2004 and/or other radio-based modems (e.g., Bluetooth 2064 or Wi-Fi 2062). The wireless modem 2060 may be configured for communication with one or more cellular networks, such as a Global system for mobile communications (GSM) network for data and voice communications within a single cellular network, between cellular networks, or between the mobile device and a public switched telephone network (PSTN). Mobile device 2000 may also communicate locally using, for example, near field communication (NFC) element 2092.

The mobile device 2000 may include at least one input/output port 2080, a power supply 2082, a satellite navigation system receiver 2084, such as a Global Positioning System (GPS) receiver, an accelerometer 2086, or a physical connector 2090, which can be a Universal Serial Bus (USB) port, IEEE 1394 (FireWire) port, RS-232 port, or other port. The illustrated components 2002 are not required or all-inclusive, as other components can be deleted or added.

Mobile device 2000 may include a multiple hover point gesture logic 2099 that is configured to provide a functionality for the mobile device 2000. For example, multiple hover point gesture logic 2099 may provide a client for interacting with a service (e.g., service 1960, FIG. 19). Portions of the example methods described herein may be performed by multiple hover point gesture logic 2099. Similarly, multiple hover point gesture logic 2099 may implement portions of apparatus described herein.

The following includes definitions of selected terms employed herein. The definitions include various examples or forms of components that fall within the scope of a term and that may be used for implementation. The examples are not intended to be limiting. Both singular and plural forms of terms may be within the definitions.

References to “one embodiment”, “an embodiment”, “one example”, and “an example” indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

“Computer-readable storage medium”, as used herein, refers to a medium that stores instructions or data. “Computer-readable storage medium” does not refer to propagated signals. A computer-readable storage medium may take forms, including, but not limited to, non-volatile media, and volatile media. Non-volatile media may include, for example, optical disks, magnetic disks, tapes, and other media. Volatile media may include, for example, semiconductor memories, dynamic memory, and other media. Common forms of a computer-readable storage medium may include, but are not limited to, a floppy disk, a flexible disk, a hard disk, a magnetic tape, other magnetic medium, an application specific integrated circuit (ASIC), a compact disk (CD), a random access memory (RAM), a read only memory (ROM), a memory chip or card, a memory stick, and other media from which a computer, a processor or other electronic device can read.

“Data store”, as used herein, refers to a physical or logical entity that can store data. A data store may be, for example, a database, a table, a file, a list, a queue, a heap, a memory, a register, and other physical repository. In different examples, a data store may reside in one logical or physical entity or may be distributed between two or more logical or physical entities.

“Logic”, as used herein, includes but is not limited to hardware, firmware, software in execution on a machine, or combinations of each to perform a function(s) or an action(s), or to cause a function or action from another logic, method, or system. Logic may include a software controlled microprocessor, a discrete logic (e.g., ASIC), an analog circuit, a digital circuit, a programmed logic device, a memory device containing instructions, and other physical devices. Logic may include one or more gates, combinations of gates, or other circuit components. Where multiple logical logics are described, it may be possible to incorporate the multiple logical logics into one physical logic. Similarly, where a single logical logic is described, it may be possible to distribute that single logical logic between multiple physical logics.

To the extent that the term “includes” or “including” is employed in the detailed description or the claims, it is intended to be inclusive in a manner similar to the term “comprising” as that term is interpreted when employed as a transitional word in a claim.

To the extent that the term “or” is employed in the detailed description or claims (e.g., A or B) it is intended to mean “A or B or both”. When the Applicant intends to indicate “only A or B but not both” then the term “only A or B but not both” will be employed. Thus, use of the term “or” herein is the inclusive, and not the exclusive use. See, Bryan A. Gamer, A Dictionary of Modem Legal Usage 624 (2d. Ed. 1995).

Although the subject matter has been described in language specific to structural features or methodological acts, it is to be understood that the subject matter defined in the appended claims is not necessarily limited to the specific features or acts described above. Rather, the specific features and acts described above are disclosed as example forms of implementing the claims.

What is claimed is:

1. A method, comprising:
detecting a plurality of hover points in a hover-space associated with a hover sensitive input/output interface associated with an apparatus;
producing independent characterization data for members of the plurality of hover points;
producing independent tracking data for members of the plurality of hover points; and
identifying a multiple hover point gesture based, at least in part, on the characterization data and the tracking data.

2. The method of claim 1, where the plurality of hover points includes up to ten hover points.

3. The method of claim 1, where detecting the plurality of hover points is performed without using a camera or a touch sensor.

4. The method of claim 1, where the characterization data for a member of the plurality of hover points describes an x position in the hover-space for the member, a y position in the hover-space for the member, a z position in the hover-space for the member, an x length measurement for the member, a y length measurement for the member, an amount of time the member has been at the x position, an amount of time the member has been at the y position, an amount of time the member has been at the z position, a likelihood that the member is a finger, a likelihood that the member is a thumb, or a likelihood that the member is a portion of a hand other than a finger or thumb.

5. The method of claim 1, where the characterization data is produced without using a camera or a touch sensor.

6. The method of claim 1, where the characterization data is produced without reference to an object displayed on the apparatus.

7. The method of claim 1, where the tracking data for a member of the plurality of hover points describes an x position in the hover-space for the member, a y position in the hover-space for the member, a z position in the hover-space for the member, an x movement amount for the member, a y movement amount for the member, a z movement amount for the member, an x motion rate for the member, a y motion rate for the member, a z motion rate for the member, an x motion duration for the member, a y motion duration for the member, or a z motion duration for the member.

8. The method of claim 1, where the tracking data for a member of the plurality of hover points describes a correlation between movement of the member and movement of one or more other members of the plurality.

9. The method of claim 1, where the tracking data is produced without using a camera or a touch sensor and where the tracking data is produced without reference to an object displayed on the apparatus.

10. The method of claim 1, where the multiple hover point gesture is a gather gesture, a spread gesture, a crank gesture, a roll gesture, a ratchet gesture, a poof gesture, or a sling shot gesture.

11. The method of claim 1, comprising generating a control event based on the multiple hover point gesture.

12. The method of claim 11, where the control event controls whether the apparatus is turned on or off, controls whether a portion of the apparatus is turned on or off, controls a volume associated with the apparatus, controls a brightness associated with the apparatus, controls whether a transmitter associated with the apparatus is turned on or off, controls whether a receiver associated with the apparatus is turned on or off, controls whether a transceiver associated with the apparatus is turned on or off, or controls whether an application running on the apparatus is on or off.

13. The method of claim 11, where the control event controls the appearance of an object displayed on the apparatus.

14. The method of claim 11, comprising determining a time period for which the control event is to be active based, at least in part, on a rate of motion described in the tracking data.

15. A computer-readable storage medium storing computer-executable instructions that when executed by a computer cause the computer to perform a method, the method comprising:
detecting a plurality of hover points in a hover-space associated with a hover sensitive input/output interface associated with an apparatus, where the plurality of hover points includes up to ten hover points, and where detecting the plurality of hover points is performed without using a camera or a touch sensor;
producing independent characterization data for members of the plurality of hover points, where the characterization data for a member of the plurality of hover points describes an x position in the hover-space for the member, a y position in the hover-space for the member, a z position in the hover-space for the member, an x length measurement for the member, a y length measurement for the member, an amount of time the member has been at the x position, an amount of time the member has been at the y position, an amount of time the member has been at the z position, a likelihood that the member is a finger, a likelihood that the member is a thumb, or a likelihood that the member is a portion of a hand other than a finger or thumb, where the characterization data is produced without using a camera or a touch sensor, and where the characterization data is produced without reference to an object displayed on the apparatus;
producing independent tracking data for members of the plurality of hover points, where the tracking data for a member of the plurality of hover points describes an x position in the hover-space for the member, a y position in the hover-space for the member, a z position in the hover-space for the member, an x movement amount for the member, a y movement amount for the member, a z movement amount for the member, an x motion rate for the member, a y motion rate for the member, a z motion rate for the member, an x motion duration for the member, a y motion duration for the member, or a z motion duration for the member, where the tracking data for a member of the plurality of hover points describes a correlation between movement of the member and movement of one or more other members of the plurality, where the tracking data is produced without using a camera or a touch sensor, and where the tracking data is produced without reference to an object displayed on the apparatus;
identifying a multiple hover point gesture based, at least in part, on the characterization data and the tracking data, where the multiple hover point gesture is a gather gesture, a spread gesture, a crank gesture, a roll gesture, a ratchet gesture, a poof gesture, or a sling shot gesture; and
generating a control event based on the multiple hover point gesture, where the control event controls whether the apparatus is turned on or off, controls whether a portion of the apparatus is turned on or off, controls a volume associated with the apparatus, controls a brightness associated with the apparatus, controls whether a transmitter associated with the apparatus is turned on or off, controls whether a receiver associated with the apparatus is turned on or off, controls whether a transceiver associated with the apparatus is turned on or off, or controls whether an application running on the apparatus is on or off.

16. An apparatus, comprising:
a processor,
a hover-sensitive input/output interface configured to produce a hover event associated with an object in a hover-space associated with the hover-sensitive input/output interface;
a memory configured to store data associated with the hover event;
a set of logics configured to process events associated with a multiple hover point gesture; and
an interface configured to connect the processor, the hover-sensitive input/output interface, the memory, and the set of logics;
the set of logics including:
a first logic configured to handle the hover event;
a second logic configured to detect a multiple hover point gesture based, at least in part, on two or more hover events generated by two or more objects in the hover-space; and
a third logic configured to generate a control event associated with the multiple hover point gesture,
where the first logic, second logic, and third logic operate without referencing touch sensor data and without referencing camera data.

17. The apparatus of claim 16, where the first logic handles the hover event by generating data for the object that caused the hover event, the data including position data, path data, and tracking data.

18. The apparatus of claim 17, where the second logic detects a multiple hover point gesture by correlating movements between the two or more objects, where the movements are correlated as a function of analyzing the position data, the path data, or the tracking data.

19. The apparatus of claim 18, where the control event is a gather event, a spread event, a crank event, a roll event, a ratchet event, a poof event, or a slingshot event, and where the control event is configured to control the apparatus, a radio associated with the apparatus, a social media circle associated with a user of the apparatus, a transmitter associated with the apparatus, a receiver associated with the apparatus, or a process being performed by the apparatus, and where the control event includes a time period over which the control event is to exert control, where the time period is based, at least in part, on a rate of motion described in the path data.

20. The apparatus of claim 19, comprising a fourth logic configured to manage a state machine associated with the multiple hover point gesture, where managing the state machine includes transitioning a process or data structure from a first multiple hover point state to a second, different multiple hover point state in response to detecting a portion of a multiple hover point gesture.
